(19) United States
(12) Patent Application Publication
(10) Pub. No.: US 2006/0168958 A1
(43) Pub. Date: Aug. 3, 2006

(54) Supercharged internal combustion engine

(76) Inventor: Jan Vetrovec, Larkspur, CO (US)

Correspondence Address: Jan Vetrovec, 8276 Eagle Road, Larkspur, CO, 80118, US

(21) Appl. No.: 11/389,795

(22) Filed: Mar. 27, 2006

Related U.S. Application Data
(63) Continuation-in-part of application No. 11/028,244, filed on Jan. 2, 2005.

(51) Int. Cl. F02B 29/04

(52) U.S. Cl. 60/599

(57) ABSTRACT

A supercharged internal combustion engine system wherein the supercharger assembly includes an ejector pump driven by high-pressure air for pumping intake air into engine combustion chamber. The ejector pump uses a supersonic driving nozzle and a diffuser, each of which can be provided either with a fixed throat area or with a variable throat area. The system includes means for sensing engine power demand and controlling the supercharging action. Effective supercharging with fast response to demand is achieved even at low engine speeds. During periods of natural engine aspiration the ejector pump can be by-passed to reduce flow impedance. The invention permits increasing power output from small displacement engines. As a result, acceleration and grade ascent capabilities of automotive vehicles with small displacement engines having good fuel economy is improved. The system can be also operated to reduce engine exhaust emissions during cold start.

This application is a continuation-in-part of U.S. Ser. No. 11/028,244 filed on Jan. 2, 2005 entitled SUPERCHARGED INTERNAL COMBUSTION ENGINE, the entire content of which is hereby expressly incorporated by reference.

### FEDERALLY SPONSORED RESEARCH

Not Applicable

### SEQUENCE LISTING OR PROGRAM

Not Applicable

### FIELD OF THE INVENTION

The present invention relates to a supercharged internal combustion engine where engine intake air is pumped by an ejector pump operated by high-pressure air to boost engine output during conditions of increased power demand.

### BACKGROUND OF THE INVENTION

Overview: The current emphasis on fuel economy in the design of power plants for automotive application motivates the efforts to improve the performance of internal combustion engines (ICE) with relatively small displacement. It is well known that automotive vehicles with small displacement engines enjoy low fuel consumption. However, under high torque conditions such as acceleration and grade ascent, small displacement ICE's often fail to provide satisfactory power. Yet, the conditions demanding high torque generally represent only about one tenth of a vehicle operating time.

Means for improving the performance of automotive vehicles powered by small displacement ICE include 1) engine supercharging and 2) a hybrid drive. Supercharging is a method of introducing air for combustion into combustion chambers of an ICE at a pressure in excess of that which can be obtained by natural aspiration (see, for example, McGraw-Hill Dictionary of Scientific and Technical Terms, 6^{th} edition, published by McGraw-Hill Companies Inc., New York, N.Y., 2003). Supercharging is accomplished with a supercharger, which is an air pump, blower or a compressor in the intake system of an ICE used to increase the weight of air charge and consequent power output from a given size engine (see, for example, the above noted McGraw-Hill Dictionary of Scientific and Technical Terms).

A hybrid drive automotive vehicle has a dual propulsion means; one driven directly by the ICE and a second one driven by a battery-operated electric motor. During low torque conditions (e.g., constant speed travel on level road), the ICE has a spare power capacity that is used to operate an electric generator and store the produced electric energy in a battery. During high-torque conditions (e.g., acceleration and/or grade ascent), electric energy is extracted from the battery to power the electric motor which assists the ICE in propelling the vehicle.

Superchargers: Supercharges have long been utilized for boosting the power output of ICE's of each spark ignition and compression ignition (also known as diesel). Superchargers can be generally classified according to their source of motive power as engine-driven and exhaust turbine-driven. The latter are also know as turbochargers. A variety of engine-driven superchargers have been developed since the early 1900's. Modern engine-driven supercharger is a positive displacement pump mechanically coupled to the engine usually by means of an on/off clutch. The clutch engages the supercharger when increased engine output is desired and disengages it to reduce engine load when high ICE output is not required. Compression in a supercharger heats up the intake air, thereby reducing its density and adversely impacting ICE performance. This condition is frequently remedied by cooling the output air of a supercharger in a heat exchanger commonly known as an intercooler prior to delivery to ICE intake passage. FIG. 1 shows a typical arrangement of an ICE having an engine-driven supercharger with an intercooler supplying compressed intake air into an intake passage leading to an ICE combustion chamber.

The types of positive displacement pumps used in engine-driven superchargers include a vane pumps (as disclosed, for example, by Casey et al., in U.S. Pat. No. 4,350,135), Roots blowers (as disclosed, for example, by Fielden in U.S. Pat. No. 2,067,757), and screw compressors also known as Lysholm compressors (as disclosed, for example, by Prior in U.S. Pat. No. 6,029,637). These pumps are expensive since they use precision machined and accurately aligned rotor components. Pump rotors spin at high speeds, typically in the range of 5,000 to 20,000 revolutions per minute (rpm), which leads to vibrations and wear. Abrasion and wear gradually increase the precision clearances between mating rotor components which results in reduced supercharger performance.

Another limitation of engine-driven superchargers is the low volumetric output at low engine speeds. This can be remedied by a variable speed drive, but only at a significant increase in complexity and cost. Engine-driven superchargers also occupy a relatively large volume which complicates their integration into engine frame. In contrast to early engine-driven superchargers that were external to the engine (as disclosed, for example, by Fielden in U.S. Pat. No. 2,067,757), modern engine-driven superchargers are typically integrated directly into the engine frame (as disclosed, for example, by Kageyama et al. in U.S. Pat. No. 6,453,890). While being more space efficient, integral supercharger obstructs other ICE components and impedes ICE serviceability. Engine-driven supercharger requires significant ICE power to operate and this power must be supplied at the least opportune moment, namely during high demand on ICE output, thus reducing ICE output power available for propulsion. Finally, an engine-driven supercharger must be engaged in a controlled manner to avoid a sudden surge in ICE intake pressure and the consequential sudden surge in output torque. This often requires a complex control system.

Another common supercharger arrangement currently in use is the turbocharger shown in FIG. 2. In a turbocharger, the ICE exhaust flow is utilized to drive an exhaust turbine, which in turn drives a compressor turbine to provide compressed air flow to the engine intake passage. Turbochargers provide the advantages of relatively smooth transitions from natural aspiration to supercharged operation while utilizing residual energy of hot exhaust gas, which would otherwise be largely wasted. However, turbochargers must run at very high rotational speeds (typically on the order of 20,000 to 100,000 rpm) and use sophisticated engineered materials to withstand the high temperatures of ICE exhaust, both of which requires rather costly construction. Another disadvantage of turbochargers is a relatively long response time lag cased by the turbine inertia. Furthermore, the nature of the exhaust gas flow and the turbine drive arrangement causes the supercharging flow to increase exponentially with engine rpm. This results in relatively inadequate boost pressures at low engine speeds and excessive boost pressures at relatively high engine speed. The latter is usually mitigated by control arrangements for reducing or limiting the output flow (e.g., using flow bypassing), but it results in a more complex design.

Ejector Pumps: Ejector pumps are widely used in industry for pumping liquids and gases, see for example, R. H. Perry and C. H. Chilton, “Chemical Engineer's Handbook,” 5^{th} edition, Chapter 6, Section “Ejectors,” pages 6-29 to 6-32, published by McGraw-Hill Book Company, New York, N.Y., 1973, and G. L. Weissler and R. W. Carlson (editors), “Vacuum Physics and Technology,” Chapter 4.3.5: Ejectors, pages 136 to 138, published by Academic Press, New York, N.Y., 1979. One key advantage of ejector pumps is that they are mechanically simple as they have no pistons, rotors, or other moving components. FIG. 3A shows a general configuration of a gas (or steam) operated ejector pump for pumping gases. In this disclosure, the term “ejector pump” shall mean a gas-operated ejector pump. Ejector pump essentially consists of a gas-operated driving nozzle, a suction chamber and a diffuser duct. The diffuser duct typically has two sections; a mixing section which may have converging and/or straight segments, and a pressure recovery section which is usually diverging. The driving nozzle is fed a high-pressure “driving” gas (or steam) at pressure p₁ and converts its potential (pressure) energy into a kinetic energy thereby producing a high-velocity gas jet discharging into the suction chamber. Pumping action occurs when the gas in the suction chamber is entrained by the jet, acquires some of its velocity, and is carried into the diffuser duct where the kinetic energy of the mixture of driving and entrained gases is converted into a potential (pressure) energy. In particular, the velocity of the gas mixture is recovered inside the diffuser to a pressure p₃ which is greater than the suction pressure p₂ but lower than the driving pressure p₁. For stable operation the diffuser exit pressure p₃ must be equal or higher than the backing pressure p₄. Ejector design is termed subsonic if the fluid velocity in the diffuser is subsonic. Conversely, ejector design is termed supersonic if the fluid velocity in the diffuser is supersonic. Hence, a supersonic ejector requires that the driving nozzle is a supersonic nozzle. Typically, diffuser ducts used in ejector pumps have a circular cross-section because it provides the largest cross-sectional area with the least circumference and, therefore, the least wall friction losses.

In practice, ejector pumps have been used to produce compression ratio p₃/p₂ of up to about 10. To achieve high compression ratio p₃/p₂ it is necessary that the driving gas pressure p₁ is much higher than the target pressure p₃ at the exit of the ejector, i.e., p₁>>p₃. Consequently, ejector pumps can be used as vacuum pumps or as compressors. A supersonic driving nozzle is preferably used to obtain efficient conversion of potential (pressure) energy of the driving gas into kinetic energy of the jet and, therefore, high compression. It is well know from thermodynamics of gases that to produce supersonic air flow in a driving nozzle requires that the nozzle pressure ratio exceeds 1.9. This means that supersonic ejectors require a relatively high-pressure gas supply. Ejector pumps can be designed to accommodate a wide variety of flow conditions. As a results, ejector pumps for different applications can greatly vary in size, nozzle and duct shape, and arrangement of components. The ejector configuration having a centrally located driving nozzle immersed in the inlet gas flow shown in FIG. 3A is known as the in-line ejector. FIG. 3B shows an alternative configuration known as the annular-jet ejector where the driving nozzle is formed as an annulus enveloping the inlet gas flow. Data on commercially produced gas ejector pumps and their performance can be found, for example, in “Pumping Gases, Jet Pump Technical Data,” Section 1000, Bulletin 1300, Issued 3/76 by Penberthy Division of Houdaille Industries, Inc., Prophetstown, Ill.

In an ejector with fixed geometry, flow throughput and pressure of driving gas can be varied to produce desired discharge port pressure p₃ over a broad range of pumped gas inflows and pressures p₂. To increase ejector pump throughput beyond the capacity of a single ejector, several ejector pumps can be operated in parallel. Alternately, multiple driving nozzles can be used to feed a single large cross-section diffuser duct (see, for example FIG. 6-71 in the above noted Perry and Chilton).

Use of Ejector Pumps in ICE: The use of ejector pumps in ICE air intake systems and exhaust systems has been disclosed in prior art. In particular, Ikeda et al. in U.S. Pat. No. 6,796,772 and U.S. Pat. No. 6,625,981 discloses ejector pumps driven by ICE intake air flow to generate vacuum for automotive braking system. However, these ejectors do not pump ICE intake air, do not increase the ICE intake air pressure, and do not supercharge the ICE.

Feucht in U.S. Pat. No. 6,267,106, Lundqvist in U.S. Pat. No. 6,502,397, Melchior in U.S. Pat. No. 3,996,748, Radovanovic et al., in U.S. Pat. No. 5,611,204, Gobert in U.S. Pat. No. 5,425,239 and Blake in U.S. Pat. No. 5,974,802 each disclose a fluid pump referred to as an “induction venturi,” “venturi,” and/or “ejector” driven by ICE intake air flow to pump ICE exhaust gases in an Exhaust Gas Recirculation (EGR) system. In all of these devices the driving gas is the intake air which flows at subsonic speeds. Therefore, the resulting compression ratio is very low albeit sufficient for EGR purposes. Furthermore, these fluid pumps do not increase the ICE intake air pressure and do not supercharge the ICE. Henderson et al. in U.S. Pat. No. 5,611,203 discloses a “multi-lobed” ejector pump operated by compressed air for pumping ERG gases into ICE air intake. This ejector pump does not increase ICE intake air pressure and does not supercharge the ICE.

Henrikson in U.S. Pat. No. 3,257,996 and Sheaffer in U.S. Pat. No. 4,461,251 each discloses an exhaust gas-operated “jet pump” for inducing atmospheric air into ICE combustion chamber. These jet pumps have subsonic driving nozzles operated by puffs of hot exhaust gas generally supplied at near ambient pressure. As a result these jet pumps are inefficient, have a low compression ratio and deliver a warm charge to ICE combustion chamber which is undesirable. In addition, the driving fluid (exhaust gas) becomes ingested in the engine. Increasing the throughput of such a jet pump requires increasing the quantity of ingested exhaust gas, which ultimately leads to increased charge temperature and limits the ICE output. Momose et al. in U.S. Pat. No. 4,418,532 discloses an air-operated ejector for pumping ICE exhaust gases. This ejector pump does not increase ICE intake air pressure and does not supercharge the ICE. Neuland in U.S. Pat. No. 2,297,910 and McWhorter in U.S. Pat. No. 5,9765,035 each discloses a subsonic ejector-like device operated by ICE exhaust gas, which is used to create a partial vacuum for inducing air into ICE combustion chamber. Since vacuum suction rather than compression is used, this device delivers engine charge at a pressure significantly lower than ambient air pressure. In addition, an exhaust gas driven ejector pump represents an impedance to exhaust gas flow and increases the pumping work done by the ICE.

Mizushina et al. in Japanese Patent Document No. JP 57210154A discloses an ejector in an ICE intake path. The ejector is operated by air supplied by a turbocharger and it is used to generate a partial vacuum to assist evaporation of fuel injected into ejector suction chamber. However, this ejector does not pump ICE intake air and does not supercharge the ICE. Arai et al. in the U.S. Pat. No. 6,082,341 discloses an ICE with a turbocharger and an eddy-flow impeller supercharger driven by ICE exhaust gases. The eddy-flow supercharger provides driving air to a converging (subsonic) ejector nozzle in the ICE intake path downstream of the turbocharger. The ejector provides only low compression and it is generally used to augment the turbocharger. Furthermore, Arai's ejector nozzle does not provide any substantial pumping or compression action during the critical ICE condition of combined low speed and high load as normally experienced at the beginning of vehicle acceleration. Suenaga et al in Japanese Patent Document No. JP 57059022A discloses an “auxiliary device” for a turbocharged ICE including an ejector located in the intake path of the turbo-compressor. The ejector has a converging (subsonic) driving nozzle which is supplied with compressed air from a storage tank. The nozzle discharges into a short duct which is placed in the ICE intake air path in such a manner so that a significant portion of the intake air bypasses the ejector nozzle and the duct by flowing on the outside of the duct. This arrangement necessarily short-circuits the ejector and limits its compression to very low values. Air flow to the Suenaga's ejector is controlled by an on/off valve. Since there are no means for continuous variation of air flow, engagement of the ejector is susceptible causing an ICE power surge. Said Arai and Suenaga each teaches means for augmenting a conventional turbocharger. In contrast, the instant invention teaches means and methods that allow eliminating conventional engine-drive superchargers and turbochargers from many automotive ICE.

Use of Compressed Air in ICE Combustion Chambers: Schier et al. in U.S. Pat. No. 4,538,584 discloses a diesel ICE wherein compressed air is fed from a tank into ICE cylinders for the purpose of engine starting. However, compressed air is not used for supercharging during normal ICE operation. Moyer in U.S. Pat. No. 5,529,549 discloses an ICE where engine cylinders are used to compress atmospheric air for storage in a tank and later use for engine supercharging. Kim et al. in U.S. Pat. No. 6,968,831 discloses a turbocharged ICE wherein compressed air from an air tank is supplied either to the inlet of turbocharger compressor or directly to the combustion chamber. In each Moyer's and Kim's concepts, all of the ICE intake air during supercharging is supplied from the storage tank. This means that the storage tank must have a large storage capacity, which translates to either a large volume or a high tank pressure, neither of which is desirable in an automotive vehicle. In addition, much of the potential (pressure) energy available in compressed air is wasted since the compressed air pressure is reduced to near ambient cylinder charge pressure without performing any useful work. Each Moyer and Kim fail to disclose means for delivery of stored air to ICE cylinders, a means for controlling the supercharging process such as the transition from natural aspiration to supercharging and a means for control of charge pressure. Moreover, neither Moyer or Kim shows how the air storage tank could be replenished by a compressor driven either by the ICE or an electric motor or a vehicle power train. Furthermore, neither Moyer or Kim discloses an ejector pump.

In summary, the prior art does not teach an ICE supercharging system that is effective at the conditions of high torque and low engine speed, has a fast response, is simple, economical, can be retrofitted onto existing ICE, does not dilute engine charge with exhaust gases, and does not rob engine of power during high power demand. Furthermore, the prior art does not teach an ICE supercharged solely by an ejector pump driven by high-pressure air. In addition, the prior art does not teach an ICE supercharged by an ejector pump with a supersonic driving nozzle. Moreover, the prior art fails to teach means for controlling the transition from natural aspiration to supercharging (and from supercharging back to natural aspiration) and a means for control of charge pressure in an ICE supercharged by an ejector pump. It is against this background that the significant improvements and advancements of the present invention have taken place.

### BRIEF SUMMARY OF THE INVENTION

The present invention provides a supercharged ICE system wherein the supercharger assembly comprises an ejector pump for pumping ICE intake air. The ejector pump further comprises a supersonic driving nozzle operated by high-pressure air. The ejector pump draws in air at a lower pressure and discharges air at a higher pressure into ICE intake passage for flowing into ICE combustion chamber. The supercharger assembly further includes means for substantially smoothly varying the flow of high-pressure air for driving the ejector pump and thereby regulating the pumping action. The supercharged ICE system further includes means for sensing ICE power demand and appropriately controlling the pumping action of the ejector pump to supercharge the ICE.

One of the central concepts of the supercharged ICE system according to the present invention applied to automotive vehicle is the recognition that under typical driving conditions the periods of high-power demand are relatively short and occur on the average only about 10% of the vehicle operating time. This means that a supercharger can be designed to operate in an intermittent mode, namely supercharging the ICE for about 10% of the vehicle operating time as demanded by vehicle driving conditions. This leaves on the average about 90% of the vehicle operating time available for recharging the supercharger.

In a first embodiment of the present invention the ICE is of the compression ignition type or fuel injected spark ignition type. The ejector pump uses a fixed throat driving nozzle for the high pressure air. An alternate driving nozzle for use with the first embodiment employs a variable area throat for regulating the mass flow of high-pressure air flowing therethrough. An alternate diffuser for use with the first embodiment employs a variable throat area that offers reduced impedance to intake air flow under normally aspirated conditions. A variant of the first embodiment includes a compressor and an air tank for providing high-pressure air for driving the ejector pump. The compressor can be directly driven by the ICE or by an electric motor or by vehicle wheel drive train. Another variant of the first embodiment includes a by-pass duct for by-passing the ejector pump when supercharging is not desired. In a second embodiment of the present invention the ICE is of the carbureted spark ignition type. In a third embodiment of the present invention the ICE is of the compression ignition type or fuel injected spark ignition type retrofitted with a supercharger assembly in accordance with the subject invention. In a fourth embodiment of the present invention the ICE is of the carbureted spark ignition type retrofitted with a supercharger assembly in accordance with the subject invention. In a fifth embodiment of the present invention the ICE system includes both a conventional supercharger and a supercharger assembly in accordance with the subject invention wherein the conventional supercharger provides supercharging at high engine speeds and the supercharger assembly in accordance with the subject invention provides supercharging at low engine speeds. A sixth embodiment of the present invention the ICE system may result (but is not limited to) from a retrofit of supercharger assembly in accordance with the subject invention onto existing ICE. The subject invention also permits providing an ICE with excess intake air and ICE supercharging during cold engine startup which, in an ICE equipped with an exhaust catalytic converter, allows the catalytic converter to reach its activation temperature in a shorter time. As a result, ICE exhaust emissions during the startup period are significantly reduced. Furthermore, the supercharger assembly in accordance with the subject invention can provide air to an ICE catalytic converter during cold engine start which allows combustion of unburned fuel exhausted from ICE combustion chamber and permits the catalytic converter to reach its activation temperature in a shorter time.

Accordingly, it is an object of the present invention to provide a supercharged ICE system which can generate a high volume intake air flow at high pressure during the conditions of high torque demand and relatively low engine speeds. Low engine speed is hereby defined as being within the lower one third (⅓) of the engine speed range. Thus, if the ICE safe operating speed range is 0 to 6,000 revolutions per minute (rpm), the low engine speed range is 0 to 2,000 rpm. The supercharged ICE system of the present invention is simple, lightweight, and inexpensive to manufacture which makes it suitable for large volume production of automotive vehicles.

It is another object of the invention to provide a supercharger assembly that has a fast response to power demand conditions.

It is another object of the invention to provide a supercharger assembly that is compact and can be easily integrated with an ICE while not significantly impeding access to other parts of the ICE.

It is yet another object of the invention to provide a supercharger assembly that is simple, robust, safe, economical, and has a low component count.

It is yet another object of the invention to provide a supercharger assembly that can be easily retrofitted to existing ICE.

It is still another object of the invention to provide a supercharged compression ignition ICE system.

It is still another object of the invention to provide a supercharged spark ignition ICE system.

It is still another object of the invention to obtain more power from small displacement ICE and thus providing automotive vehicles with sufficient acceleration in addition to good fuel economy.

It is a further object of the invention to provide a booster stage for a conventional supercharger (engine-driven supercharger or turbocharger) for improving supercharging performance at low engine rpm and reducing supercharger response time.

It is yet further object of the invention to reduce ICE exhaust emissions during cold engine start.

It is still further object of the invention to provide a supercharger that can be used with hybrid vehicles to boost the power of the ICE and thus giving the hybrid vehicle more power to accelerate and ascend grade.

These and other objects of the present invention will become apparent upon a reading of the following specification and claims.

### BRIEF DESCRIPTION OF THE DRAWINGS

FIG. 1 is a schematic view of a supercharged ICE of prior art with an engine-driven supercharger.

FIG. 2 is a schematic view of a supercharged ICE of prior art with a supercharger driven by an exhaust gas turbine.

FIG. 3A is a cross-sectional diagram of a prior art in-line ejector pump.

FIG. 3B is a cross-sectional diagram of a prior art annular jet ejector pump.

FIG. 4 is a schematic view of a supercharged ICE in accordance with a first embodiment of the subject invention.

FIG. 5 is a flow charts showing preferred control operations of an electronic control unit.

FIG. 6 is a schematic view of an alternative ejector pump with a variable area driving nozzle.

FIG. 7A is a cross-sectional view of a variable area driving nozzle wherein the nozzle throat is adjusted for a larger area.

FIG. 7B is a cross-sectional view of a variable area driving nozzle wherein the nozzle throat is adjusted for a smaller area.

FIG. 8 is a schematic view of a supercharger assembly according to a first variant of a first embodiment of the subject invention.

FIG. 9 is a schematic view of a supercharger assembly according to a second variant of a first embodiment of the subject invention.

FIG. 10 is a schematic view of a supercharged carbureted ICE in accordance with a second embodiment of the subject invention.

FIG. 11 is a schematic view of a supercharged ICE in accordance with a third embodiment of the subject invention having a retrofitted supercharger assembly.

FIG. 12 is a schematic view of a supercharged carbureted ICE in accordance with a fourth embodiment of the subject invention having a retrofitted supercharger assembly.

FIG. 13 is a schematic view of a supercharged ICE in accordance with a fifth embodiment of the subject invention having a supercharger assembly in addition to a conventional supercharger.

FIG. 14 is a schematic view of an alternate ejector pump with several driving nozzles injecting high-velocity jets into a single diffuser duct.

FIG. 15 is a schematic view of another alternate ejector pump assembly with multiple ejectors connected in parallel.

FIG. 16A is a cross-sectional view of a variable area diffuser duct wherein the diffuser throat is adjusted for a larger area.

FIG. 16B is an end view of the diffuser duct in FIG. 16A looking upstream.

FIG. 16C is a cross-sectional view of a variable area diffuser duct wherein the diffuser throat is adjusted for a smaller area.

FIG. 16D is an end view of the diffuser duct in FIG. 16C looking upstream.

FIG. 16E is a cross-sectional view of a variant of the variable area diffuser duct wherein the diffuser throat is adjusted for a larger area.

FIG. 16F is an end view of the diffuser duct in FIG. 16E looking upstream.

FIG. 16G is a cross-sectional view of the variant of variable area diffuser duct wherein the diffuser throat is adjusted for a smaller area.

FIG. 16H is an end view of the diffuser duct in FIG. 16G looking upstream.

FIG. 17A is an end-view of a turbulence reducing device.

FIG. 17B is a side view of a turbulence reducing device.

FIG. 18 is a schematic view of a supercharged ICE in accordance with a sixth embodiment of the subject invention which may result after retrofitting a supercharger of the instant invention onto existing ICE.

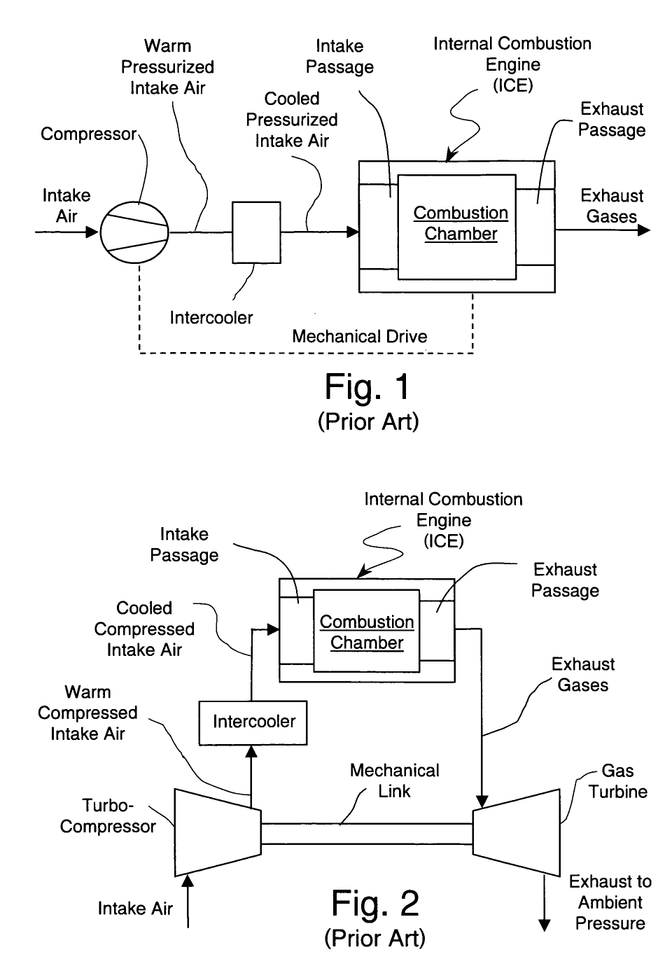

### DETAILED DESCRIPTION OF THE PREFERRED EMBODIMENTS

Selected embodiments of the present invention will now be explained with reference to drawings. It will be apparent to those skilled in the art from this disclosure that the following descriptions of the embodiments of the present invention are merely exemplary in nature and are in no way intended to limit the invention, its application, or uses.

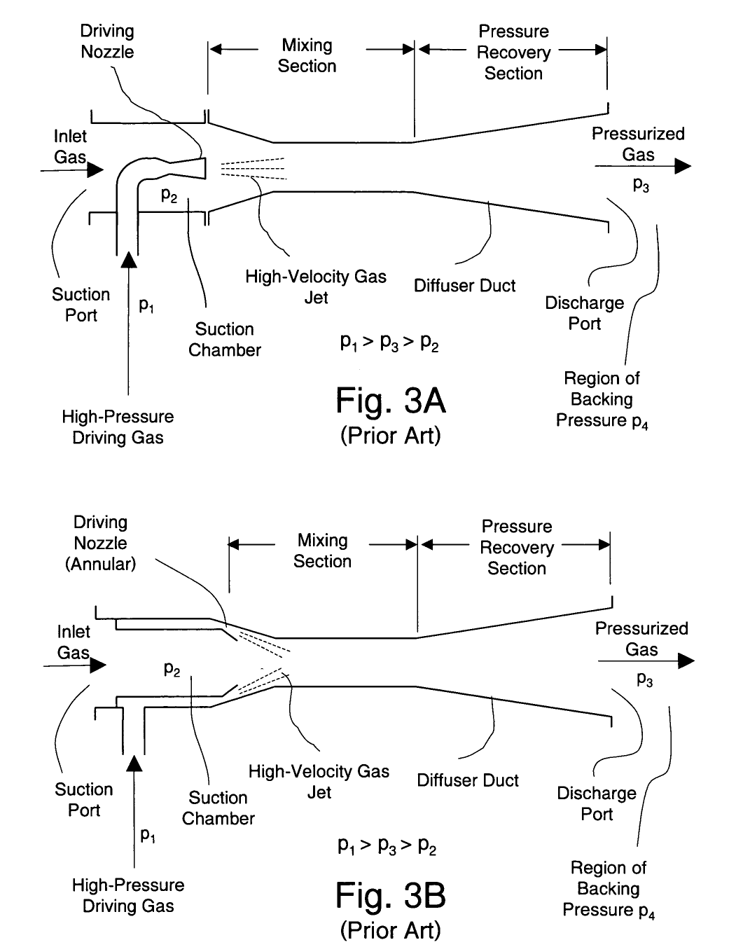

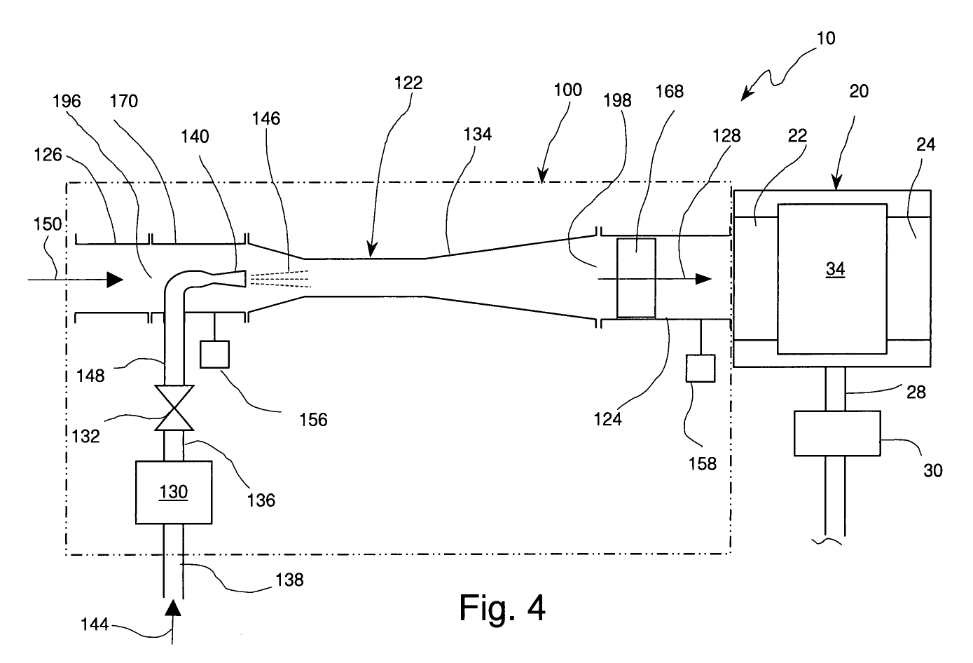

Referring to FIG. 4 there is shown a supercharged internal combustion engine (ICE) system 10 in accordance with a first embodiment of the subject invention. The ICE system 10 comprises an ICE 20 and a supercharger assembly 100. The ICE 20 has at least one combustion chamber 34 fluidly connected to an intake passage 22 and to an exhaust passage 24. The type of ICE 20 can be either a compression ignition (diesel), a fuel injected spark ignition, or homogeneous charge compression ignition (HCCI) also known as controlled auto-ignition (CAI). If ICE 20 is fuel injected with spark ignition, the intake passage 22 can also include a fuel injector (not shown). Furthermore, the ICE 20 can also include an output shaft 28 and a torque sensor 30 for sensing ICE output torque. The supercharger assembly 100 includes an intake duct 126, transition duct 124, an ejector pump 122, high-pressure air supply line 138, on/off valve 132, pressure regulator 130, interconnecting line 136 and air feed line 148. The ejector pump 122 further includes a driving nozzle 140, a suction chamber 170 having a suction port 196, and a diffuser duct 134 having a discharge port 198. The driving nozzle 140 is a supersonic nozzle adapted for generation of supersonic flow. Suitable types of such supersonic nozzles include the convergent-divergent type nozzle also known as the Laval nozzle (shown, for example, in FIGS. 3A and 4), the annular nozzle (shown in FIG. 3B), the plug nozzle, the spike nozzle (see, for example, the above noted McGraw-Hill Dictionary of Scientific and Technical Terms), and the expansion-deflection nozzle.

The diffuser duct 134 preferably has a circular cross-section which is known for its low wall friction losses. However, other cross-sections including oval, ellipse, square, rectangle, and polygonal shape can be also used. The diffuser duct 134 preferably has an upstream converging section, which is followed by a straight middle section that is followed by a downstream divergent section. As already noted, such a diffuser duct design is considered conventional for use with ejector pumps. However, the subject invention can be practiced with alternative diffuser designs. For example, an alternative design of the diffuser duct 134 can have only a straight section followed by a divergent section. Another alternative design of the diffuser duct 134 can have only a straight section. The preferred size and shape of the diffuser duct 134 is determined in accordance with a desired pressure recovery.

If desirable, the transition duct 124 can also include an intercooler 168 to reduce the temperature of gas passing therethrough. As noted above, use of an intercooler for cooling of intake air compressed by a supercharger is a common practice in the art. However, in the present invention, the need for an intercooler is substantially lower than in a comparable engine-driven supercharger or a turbocharger because only a portion of the gasses flowing through of the ejector pump 122 is actually compressed and, therefore, production of compression related heat is substantially lower. The intercooler 168 can reject heat from intake air to liquid coolant (air-liquid intercooler) or atmospheric air (air-air intercooler). The air-liquid and air-air intercoolers are commonly used in the art. Alternatively, the intercooler 168 can be constructed to have a large thermal capacity. In this case, the heat removed from intake air during a supercharging event is stored in the thermal capacity of the intercooler and released during normal ICE aspiration. As a yet another alternative, the intercooler structure can include a phase change material (PCM) to absorb heat during supercharging events and to release stored heat when supercharging is not used. This type of intercooler with PCM has been disclosed by Tholen in U.S. Pat. No. 4,660,532. The preferred PCM materials include stearin which is known to have a transition temperature in the range of 50-70 degrees Centigrade. The intake duct 126 is fluidly connected to a source of atmospheric air generally at near ambient pressure. For example, the inlet of the intake duct 126 can be fluidly connected to the outlet of an ICE intake air filter (not shown). The transition duct 124 is fluidly connected to the intake passage 22. The ejector pump 122, therefore, fluidly couples the intake duct 126 to the transition duct 124.

The pressure regulator 130 is fluidly connected to a source of high-pressure air by means of line 138 and to the on/off valve 132 by the line 136. High-pressure air stream 144 supplied in line 138 preferably has a pressure in the range of 50 to 300 pounds-per-square-inch gage (psig). The upper limit of this range is primarily due to safety considerations over a possible rupture of high-pressure lines and storage vessels in the event of a vehicle collision or fire. Thus, the upper limit can be exceeded if safety considerations permit. The pressure regulator 130 is preferably remotely controllable. Suitable pressure regulators that are remotely controllable either electrically, pneumatically, hydraulically, or mechanically have been disclosed in prior art and are available commercially. The on/off valve 132 is fluidly connected by the line 148 to the driving nozzle 140. Air pressure and temperature sensors can be also provided in line 148 downstream of valve 132 to aid in accurate monitoring of mass flow through the nozzle 140. The supercharger assembly 100 can further include a pressure sensor 156 for sensing the pressure in suction chamber 170 and a pressure sensor 158 for sensing the pressure in transition duct 124. An engine throttle, if used, can be located either upstream or downstream of the supercharger assembly 100. Alternatively, the throttle can be located in the transition duct 124.

When ICE 20 operates in a naturally aspirated mode (i.e., without supercharging), the on/off valve 132 is closed. Intake air stream 150 preferably free of dust and solid particulates enters the intake duct 126, flows through the suction chamber 170 past the driving nozzle 140, through the diffuser duct 134, through the transition duct 124, through intercooler 168 (if used), and forms an intake air stream 128 flowing into the intake passage 22 of ICE 10. The ejector pump 122, the intake duct 126, and transition duct 124 are preferably arranged to provide low impedance to the air flowing therethrough.

When ICE 20 operates in a supercharged mode, the pressure regulator 130 receives high-pressure air 144 at pressure pₒ from line 138 and flows high-pressure air at a predetermined pressure p₁ (which is less than or equal to pressure pₒ) into line 136. To generate supersonic air flow in nozzle 140, the nozzle pressure ratio should be at least 1.9. Thus, pressure p₁ should be at least 1.9 times the pressure p₂ in suction chamber 170. A preferred range for pressure p₁ is from about 50 to about 300 psig. The on/off valve 132 is in open position and allows the high-pressure air to flow thorough line 148 to the driving nozzle 140. The high-pressure air expands in the driving nozzle 140 and discharges into the suction chamber 170 of the ejector pump 122 where it forms a high-velocity jet 146 directed into the diffuser duct 134. Intake air stream 150 preferably free of dust and particulates enters through the intake duct 126 and suction port 196 into the suction chamber 170 at pressure p₂, where it is entrained by the high-velocity jet 146 and swept by the jet into the diffuser duct 134, thereby producing a high-velocity mixed flow. The diffuser 134 converts the kinetic energy of the mixed flow into a potential (pressure) energy, thereby producing an intake air stream 128 at pressure p₃. Pressure p₃ is substantially higher than pressure p₂ in suction chamber 170.

The ICE system 10 preferably includes an electronic control unit (ECU) (not shown). The electronic control unit (ECU) is preferably comprised of a central processing unit, a read-only memory, random access memory, input and output ports, and the like. The ECU is configured to receive signals from sensors in the ICE system 10, to determine whether certain predetermined conditions exist based on the measured parameters. At any time during ICE operation, the ECU preferably monitors one or more operating parameters of the ICE system 10 and regulates the flow rate through the driving nozzle 140 by operatively controlling the pressure regulator 130 and the on/off valve 132 according to predetermined conditions. Operating parameters monitored by the ECU preferably include engine rotational speed, engine output torque, fuel flow rate, vehicle speed, throttle opening, and position of accelerator pedal. Other useful parameters monitored by the ECU include ambient air pressure, intake air mass flow rate, intake air pressure and temperature, and detection values of pressure sensors 156 and 158. The torque value can be either directly measured (for example, the torque value can be the detection value from the torque sensor 30) or it can be inferred from other ICE parameters. In particular, it is well known that engine torque value can be estimated from one or more ICE parameters including intake air mass flow rate, spark timing, or combustion chamber pressure data as noted, for example, by T. Jaine et al. in “High-Frequency IMEP Estimation and Filtering for Torque-Based SI Engine Controls,” SAE paper number 2002-01-1276, published by the Society of Automotive Engineers, Inc., Warrendale, Pa. Alternatively to using an ECU, various electrical, mechanical and electromechanical control mechanisms can be used to operate the valve 132 and the pressure regulator 130 in response to predetermined conditions. It will be apparent to those skilled in the art from this disclosure that the precise structure and algorithms for the ECU can be any combination of hardware and software that will carry out the functions of the present invention.

During ICE operation the suction chamber 170 is at pressure p₂, which could be below ambient atmospheric pressure, depending on the choice of components upstream of the intake duct 126 and the engine rotational speed. It is assumed that the pressure p₃ at the discharge port 198 is essentially the same as the pressure in the intake passage 22. During the operation of the supercharger assembly 100, at a given combination of engine rotational speed and pressure p₂ in suction chamber 170, the intake passage 22 pressure p₃ can be regulated by varying the mass flow rate through the driving nozzle 140. Assuming that the driving nozzle 140 has a fixed throat area, its mass flow rate is substantially defined by the nozzle static pressure, which is essentially the same as the pressure p₁ in line 148. Consequently, the ICE charge pressure can be regulated by appropriately controlling the pressure regulator 130. The intake duct 126 may also contain a valve which can be arranged to close during supercharging so that all of the intake air is provided by the nozzle 140.

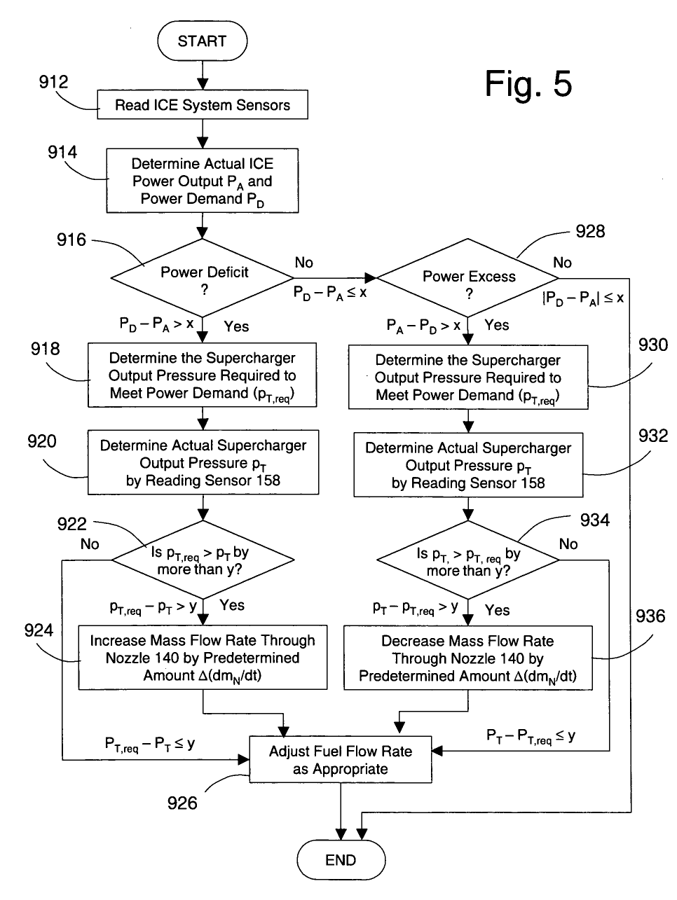

There is a variety of processes the ECU can employ for controlling the supercharging action in ICE system 10. Preferably, the ECU repeatedly executes the routine represented by the flowchart shown in FIG. 5. Referring now to FIG. 5, after the routine is started and the ECU obtains detection values of various ICE system sensors to determine ICE state (step 912). Such sensors may include, but are not limited to ICE rotational speed, position of accelerator pedal, throttle opening, fuel flow rate, vehicle speed, ICE output torque, air pressure and temperature in the transition duct 124 (FIG. 4), air velocity in the transition duct, air pressure in line 138, setting of the pressure regulator 130, position of valve 132, air pressure and temperature in ICE intake passage 22, and ambient air pressure and temperature. Preferably, the ECU calculates the actual ICE power output (P_{A}) and the power output being demanded from the ICE (P_{D}) (step 914). Based on obtained parameters the ECU determines whether or not an ICE power deficit exists (step 916). This can be accomplished, for example, by comparing the values of the actual ICE power output P_{A} and the demanded ICE power output (power demand) P_{D}. A power deficit is established when, for example, the power demand P_{D} is greater than the actual ICE power output P_{A} by more than a predetermined amount x (namely, P_{D}−P_{A}>X).

If a power deficit exists, the ECU then calculates the air pressure (p_{T,req}) in the transition duct 124 (supercharger output pressure) required to meet the power demand at optimum throttle opening (if throttle is used) and air-fuel ratio (step 918). If the ICE has an electronically controlled throttle, an optional next step (not shown) can include opening of the throttle by a predetermined amount. The ECU then obtains actual supercharger output pressure measurement (p_{T}) by obtaining the detection value of pressure sensor 158 in the transition duct 124 (step 920). The values of the required pressure p_{T,req} and the actual pressure p_{T} in the transition duct are then compared (step 922). If the required pressure value p_{T,req} is greater than the actual pressure value p_{T} by more than a predetermined amount y (namely, p_{T,req}−p_{T}>y), the ECU increases the mass flow rate dm_{N}/dt through nozzle 140 by a predetermined incremental amount Δ(dm_{N}/dt) (step 924). This can be accomplished by increasing the output pressure of pressure regulator 130 with the valve 132 in open position. The value of incremental amount Δ(dm_{N}/dt) can be made generally proportional to the difference between the required and actual pressures in the transition duct (namely, Δ(dm_{N}/dt)∝p_{T,req}−p_{T}). If desired, the incremental amount Δ(dm_{N}/dt) can be appropriately limited not to exceed a predetermined value, and such a value can be updated each time the routine of FIG. 5 is executed. This approach can be used to avoid abrupt changes in supercharger output pressure and consequential surge in ICE output. Preferably, an increase in the supercharging action is performed so that ICE power is increased in a smooth fashion and with prompt response to demand. To assure proper air-fuel ratio, ECU can adjust fuel flow rate as appropriate to improve ICE performance (step 926) and the routine is ended. If the required pressure value p_{T,req} is not greater than the actual pressure value p_{T} by more than a predetermined amount y (namely, p_{T,req}−p_{T}≦y) (step 922), no change to the supercharger condition is required. Then the ECU can adjust fuel flow rate as appropriate for improved ICE performance (step 926) and the routine is ended.

If the ECU determines that a power deficit does not exist (step 916), the ECU then evaluates whether a power excess exists (step 928). A power excess is established when, for example, the demand power output P_{D} is smaller than the actual ICE power output P_{A} by more than a predetermined amount x (namely, P_{A}−P_{D}>X). If a power excess exists, the ECU then calculates the air pressure p_{T,req} in the transition duct 124 required to meet the power demand at optimum throttle opening (if throttle is used) and air-fuel ratio (step 930). If the ICE has an electronically controlled throttle, an optional next step (not shown) can include closing of the throttle by a predetermined amount. The ECU then obtains actual supercharger output pressure measurement p_{T} by obtaining the detection value of pressure sensor 158 in the transition duct 124 (step 932). The values of the required pressure p_{T,req} and the actual pressure p_{T} in the transition duct are then compared (step 934). If the required pressure value p_{T,req} is smaller than the actual pressure value p_{T} by more than a predetermined amount y (namely, p_{T}−p_{T,req}>y), the ECU decreases the mass flow rate dm_{N}/dt through nozzle 140 by a predetermined incremental amount Δ(dm_{N}/dt) (step 936). This can be accomplished by decreasing the output pressure of pressure regulator 130 with the valve 132 in an open position or by closing the valve 132. The value of incremental amount Δ(dm_{N}/dt) can be made generally proportional to the difference between the actual and the required pressures in the transition duct, namely Δ(dm_{N}/dt)∝(p_{T}−p_{T,req}). If desired, the incremental amount Δ(dm_{N}/dt) can be appropriately limited not to exceed a predetermined value which can be updated each time the routine of FIG. 5 is executed. This approach can be used to avoid abrupt changes in air pressure inside the transition duct and consequential abrupt loss of ICE output. Preferably, a reduction in supercharging action is performed so that ICE power is decreased in a smooth fashion and with prompt response to demand. To assure proper air-fuel ratio, ECU can adjust fuel flow rate as appropriate to improve ICE performance (step 926) and the routine is ended. If the actual pressure value p_{T} is not greater than the required pressure value p_{T,req} in the transition duct by more than a predetermined amount y (namely, p_{T}−p_{T,req}≦y) (step 922), no change to the supercharger condition is required. Then, the ECU can adjust fuel flow rate as appropriate for improved ICE performance (step 926) and the routine is ended.

If in step 928 it is established that value of P_{D}−P_{A} is less than or equal to predetermined value x, it means that the absolute value of P_{D}−P_{A} is less than or equal to predetermined value x (namely, |P_{D}−P_{A}|≦X). In such a case, neither power deficit or power excess exist and the routine is ended. This conditions may correspond to an automotive vehicle cruising on level road or an ICE operating in idle. To assure that ICE system 10 promptly responds to demand, the routine in FIG. 5 should be executed at a rapid repetition rate, preferably 10 to 100 times per second.

Alternative routine responding to torque demand rather than power demand can be also implemented. Such a routine can be identical to the one shown in FIG. 5 except that in steps 914, 916, and 928, the term “power” is replaced with the term “torque”. Suitable methods for determining demand torque value are known in the art and include determination of demand torque from position of vehicle acceleration pedal. See, for example, N. Heintz et al., in “An Approach to Torque-Based Engine Management Systems,” SAE paper number 2001-01-0269, published by the already noted Society of Automotive Engineers. Another alternative routine can be used if ICE system 10 has means for measuring intake air mass flow. Such a routine can be identical to the one shown in FIG. 5 except that in steps 918, 920, 922, 930, 932 and 934, the terms “p_{T,req}” and “p_{T}” are replaced respectively with the terms “dm_{T,req}/dt” and “dm_{T}/dt” where dm_{T,req}/dt is the mass flow of air required to meet ICE output demand and dm_{T}/dt is the actual mass flow of air measured flowing through the transition duct 124. Another variant of the routine in FIG. 5 can omit steps 918, 920, 922, 930, 932, and 934.

Alternative criteria for establishing power deficit and power excess conditions include: 1) Power deficit condition is established when engine rotational speed is less than predetermined engine rotational speed value and engine output torque is more than a predetermined engine output torque value. Accordingly, power excess condition is established when engine rotational speed is more than predetermined engine rotational speed value and engine output torque is less than a predetermined engine output torque value. 2) Power deficit condition is established when engine rotational speed is less than predetermined engine rotational speed value and engine fuel flow rate is more than a predetermined fuel flow rate value. Accordingly, power excess condition is established when engine rotational speed is more than predetermined engine rotational speed value and engine fuel flow rate is less than a predetermined fuel flow rate value. 3) Power deficit condition is established when the actual engine torque (measured or inferred) value is less than the demand torque value calculated from the position of accelerator pedal. Accordingly, power excess condition is established when the actual engine torque (measured or inferred) value is more than the demand torque value calculated from the position of accelerator pedal.

### EXAMPLE 1

Consider a 4-cycle ICE with a 2 liter displacement. When operating at 1200 rpm the engine displaces 20 liters per second. Assume that under naturally aspirated conditions, the intake passage pressure is about 540 Torr (about 21.25 inches Hg), which translates to an intake air flow of about 14 standard liters per second (about 28 standard cubic feet per minute). When equipped with the supercharger assembly 100, the ICE can be supercharged and the pressure in the intake passage 22 can be theoretically increased to 680 Torr (about 27 inches Hg) by flowing approximately 10 standard liters per second of air through the driving nozzle 140 of the ejector pump 122. This could theoretically boost the ICE power output by about 25%.

As noted above, operation of the ejector pump 122 is controlled by regulating the flow through the nozzle 140, which in turn is regulated by the setting of the pressure regulator 130 (FIG. 4). One disadvantage of this approach is that the pressure regulator 130 causes a significant pressure drop in the high-pressure air flow. Unless such a pressure drop is compensated by an increased pressure pₒ of high-pressure air 144 in supply line 138, the control range of mass flow through the driving nozzle 140 is significantly reduced. An alternative approach for controlling a mass flow through a supersonic nozzle is to vary the nozzle throat area rather than the nozzle feed (static) pressure. Nozzles with variable flow area have been disclosed in prior art for example by Friedlander et al. in the U.S. Pat. No. 6,681,560 and Bubniak et al. in the U.S. Pat. No. 4,054,621.

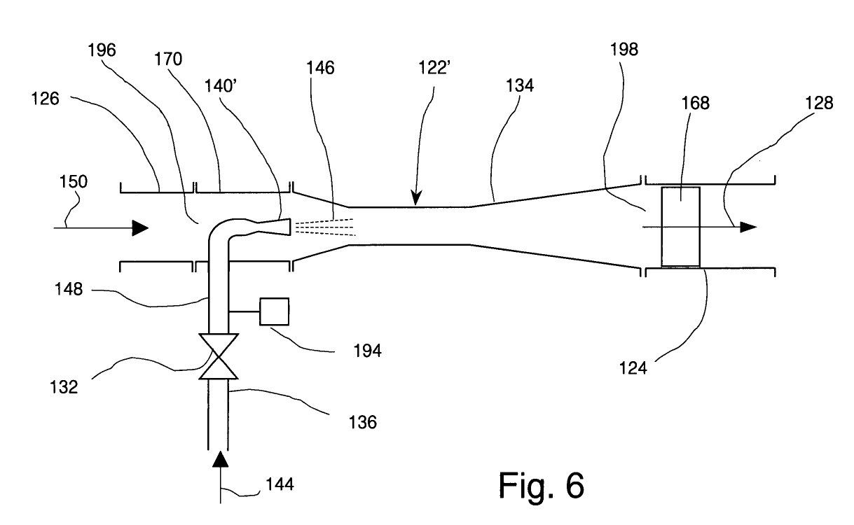

Referring now to FIG. 6 there is shown an alternative ejector pump 122′ having a variable area driving nozzle 140′ connected to air supply line 138 by means of an on/off valve 132 and feed line 148. During an operation of the supercharger 100, the ECU obtains the value of air pressure in line 148 by reading the pressure sensor 194 and sends out control signals to appropriately adjust the throat area of the driving nozzle 140′ so that a predetermined mass flow rate therethrough is produced. Valve 134 is preferably chosen to have a low pressure drop at the maximum rated mass flow rate through the nozzle 140 and it is operated in already described manner as necessary to supercharge the ICE 20.

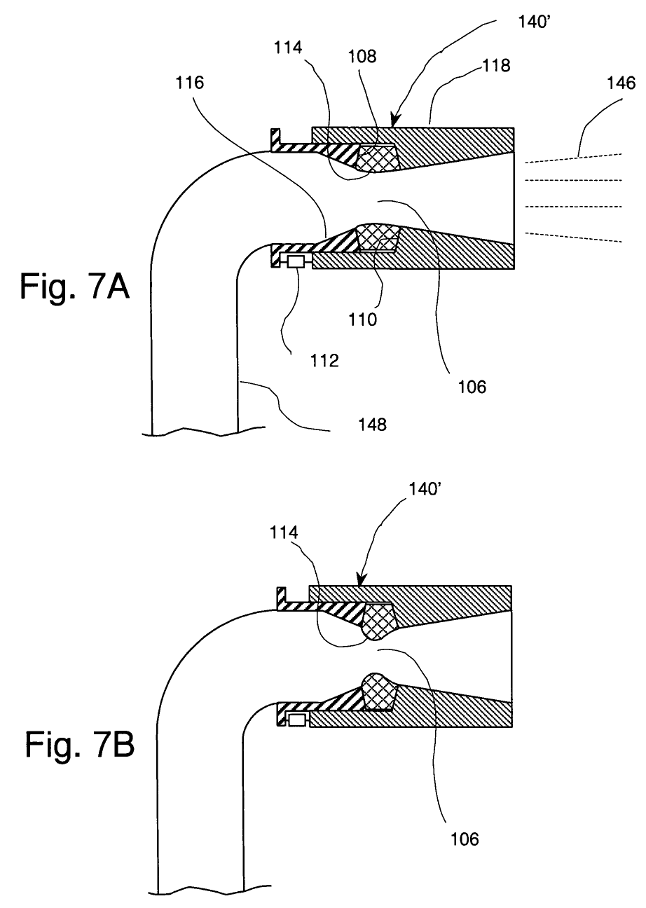

Referring now to FIGS. 7A and 7B, there is shown a cross-sectional view of a variable area driving nozzle 140′ suitable for use with the subject invention. FIG. 7A shows the driving nozzle 140′ comprising a nozzle inlet 116 fluidly coupled to feed line 148, nozzle outlet 118 slidingly attached over nozzle inlet 116, elastic throat element 114, and actuator 112 for adjusting the relative position of nozzle inlet 116 and nozzle outlet 118. The nozzle inlet 116 has a surface 108 and the nozzle outlet 118 has a surface 110. Surfaces 108 and 110 engage the elastic throat element 114 and compress it. The force of compression is provided by actuator 112 which slides the nozzle outlet 118 over the nozzle inlet 116. The elastic throat element 114 is made of suitable elastic material, preferably rubber, urethane, polyurethane or other suitable elastomer formed to a generally toroidal shape. Central opening in the elastic throat element 114 defines the nozzle throat 106. The actuator 112 can be operated mechanically, electromechanically, piezzo-electrically, hydraulically, pneumatically, or by other suitable means. One or more actuators can be used. Compression by surfaces 108 and 110 distorts the elastic throat element 114. FIG. 7B shows the elastic throat element 114 in a distorted condition and having some of its material forced toward the nozzle center, thereby reducing the area of nozzle throat 106. Hence, the size of nozzle throat area is controlled by the force applied by actuator 112. The driving nozzle 140′ is operated by feeding high-pressure air via line 148 into the nozzle inlet 116 and through the throat 106 into the nozzle outlet 118 where it is expanded to a high velocity jet 146 (FIG. 7A).

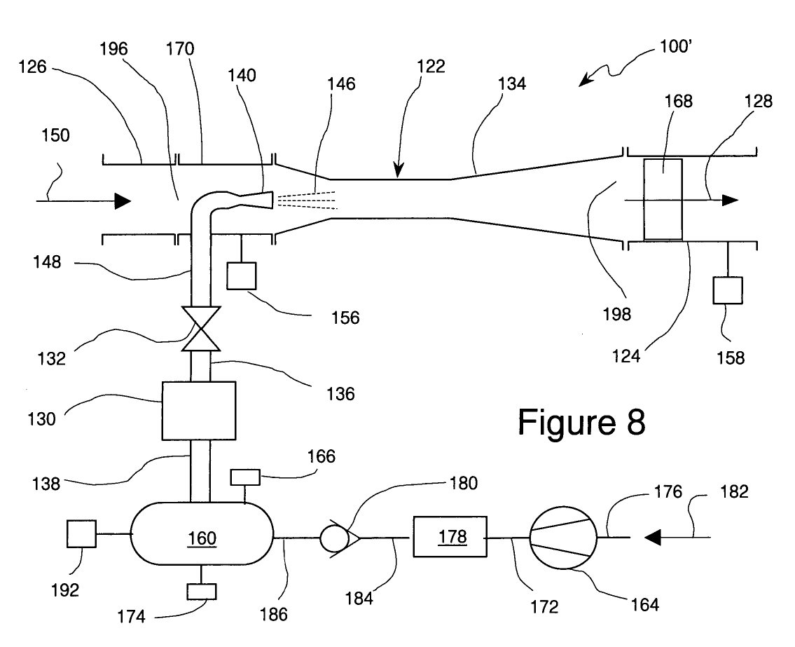

The supercharger assembly 100 shown in FIG. 4 is particularly suitable for supercharging ICE in vehicles such as trucks, earth moving equipment, and utility vehicles that already have an existing supply of high-pressure air. However, smaller vehicles such as motorcycles and passenger automobiles normally do not have a built-in supply of high-pressure air. To enable the use of subject invention in such applications, a supply of high-pressure air can be made an integral part of the supercharger assembly. Referring now to FIG. 8, there is shown a supercharger assembly 100′ in accordance with a first variant to the supercharger assembly 100 of the first embodiment of the present invention. The supercharger assembly 100′ is essentially the same as the supercharger assembly 100, except that it further includes a compressor 164, air tank 160, aftercooler 178, check valve 180 and lines 176, 172, 184, and 186.

The compressor 164 can be of any suitable type including piston, vane, scroll, diaphragm, and screw type (also known as Lysholm). The compressor 164 is preferably driven by the output shaft of ICE 220 via direct coupling or a belt drive (not shown). An on/off clutch can be included in the drive to engage the compressor on as-need basis. Suitable on/off clutch can be controlled mechanically, electrically, pneumatically, or hydraulically. Alternatively, compressor 164 can be driven by an electric motor. As a yet another alternative, compressor 164 can be driven from the vehicle power train which is directly coupled and provides motive power to vehicle wheels. Such a power train is typically located between the vehicle transmission and the differential. In this case, the compressor can be engaged (by a clutch or a load control valve) preferentially when the vehicle brakes are applied and the air tank 160 can be recharged using energy which would otherwise be wasted as heat in the brakes. The air tank 160 is preferably equipped with a pressure switch 166 having one higher setting and one lower setting. The pressure switch 166 is wired to the controls of the compressor 164 (and/or to the on/off clutch, if used) so that the compressor 164 maintains the pressure in air tank 160 between said lower and higher settings. The compressor can be also equipped with an unloader valve which automatically relieves the compressor of the pumping load when air tank 160 is charged to a predetermined pressure. The air tank design and choice of materials are preferably selected to reduce the likelihood of tank rupture during vehicle collision and/or fire. While a metal tank is acceptable in some applications, a composite tank construction is considered more suitable for use in road vehicles. A preferred tank design includes a think metal liner wrapped in high-strength fiber imbedded in epoxy resin matrix as disclosed, for example, by DeLay in in U.S. Pat. No. 6,953,129. Preferred high-strength fibers include aramid fibers which are extremely tough and tear resistant so that splintering in the event of tank burst is preventable. Particularly preferred are p-aramid fibers produced by DuPont, Wilmington, Del. under the trademark Kevlar® as disclosed, for example, by Logullo et al. in U.S. Pat. No. 4,767,017. The construction of tank 160 may also include suitable phase change material which renders the tank significantly more fire resistant as disclosed, for example, by Zukerman et al. in U.S. Pat. No. 6,207,738. It should be noted that the maximum operating pressure of tank 160 is limited by its burst resistance, especially in case of vehicle collision and/or fire. Safety of the supercharger 100′ can be increased by using a plurality of smaller interconnected tanks rather than a single large tank 160. The air tank 160 can also include a pressure sensor 192 which can be read by the ECU to determine the amount of air stored. This information can be used to control the operation of the supercharger 100′ and can be also made available to the operator of the automotive vehicle. The tank 160 preferably contains one or more pressure relief valves to prevent overpressure. In addition, the air tank 160 preferably contains an automatic drain valve 174 for automatic expulsion of water condensate that has formed inside the tank. Suitable automatic drain valves are commercially available, for example, from Wilkerson Corporation in Englewood, Colo. Liquid water removed from the air tank 160 can be collected and used to replenish water in the ICE cooling system, the windshield washing reservoir or used to operate an electrolytic cell for production of hydrogen. To prevent water condensate accumulated inside the air tank 160 from freezing during cold weather operation, the tank or at least a lower portion thereof can be heated either electrically or by a thermal contact with ICE coolant. The aftercooler 178 is of the same general type used in conventional compressed air systems to remove the heat of compression from the air down stream of the compressor, and it can be cooled by ambient air or by ICE coolant. Alternatively, intercooler 178 can have a dedicated liquid coolant loop. The check valve 180 prevents a backflow of high-pressure air from the air tank 160 into the compressor 164 when the compressor is not active. Line 184 can also include a water separator to remove water condensate from cooled air flow. Liquid water so recovered can be used in already described manner.

During operation of the compressor 164, an air stream 182 at about ambient pressure and preferably free of dust and solid particulates is drawn through line 176 into the compressor 164 where it is compressed to pressure pₒ. As an option, the air stream 182 can originate from the intake air stream 150. Output of the compressor 164 is fed through line 172 into the aftercooler 178 where the heat of compression is largely removed, and through line 184, check valve 180 and line 186 into the tank 160. As already noted, under average driving conditions the ejector pump draws high-pressure air from the air tank on the average only about 10% of the vehicle operating time. Since the compressor 164 can run with up to continuous duty, this means that its size can be relatively modest. If the compressor 164 is operated directly from ICE shaft 28, pumping action of the compressor can be discontinued during periods of ICE supercharging to make more of the ICE output power available for vehicle propulsion.

### EXAMPLE 2

Using the ICE and supercharger parameters from Example 1 with high-pressure air flow of 10 standard liters per second, the ejector pump consumes 100 standard liters in a 10-second supercharging event. Assuming that supercharging is necessary (on the average) about 10% of the vehicle operating time, the compressor has (on the average) about 100 seconds to replenish the high-pressure air in the air tank. Thus, the average flow rate through the compressor is about 1 standard liter per second (about 2.3 standard cubic feet per minute). A suitable piston type compressor delivering high-pressure air at this flow rate would weigh about 7 kilograms (15 lbs), occupy a volume of about 5 liters (324 cubic inches) and require about 1 horsepower to operate. Evidently, power required to operate the compressor represents only a small fraction of ICE output. As already noted, during a supercharging event the ICE system power output would theoretically increase by about 25%.

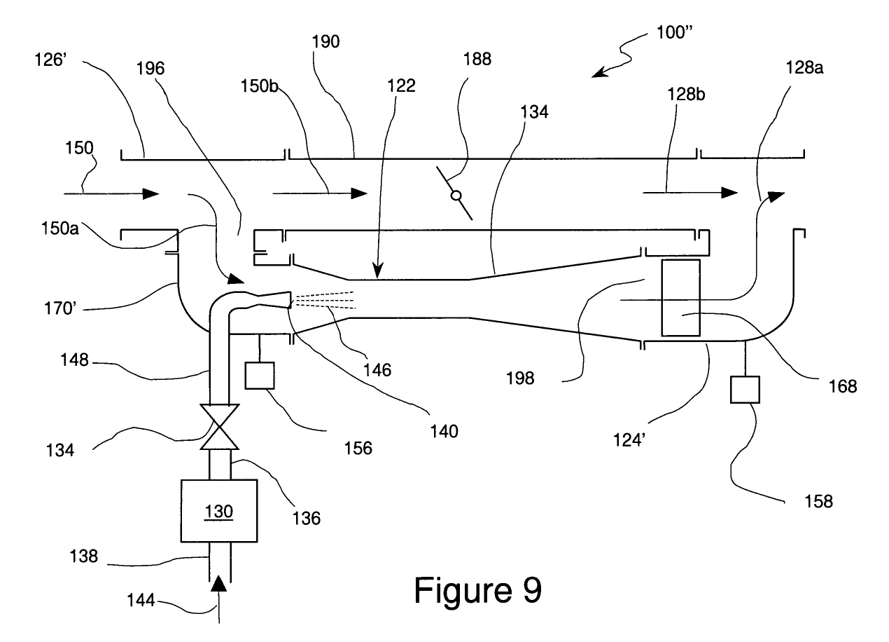

Referring now to FIG. 9, there is shown a supercharger assembly 100″ in accordance with a second variant to the supercharger assembly 100 of the first embodiment of subject invention having reduced intake air flow impedance during natural aspiration. The supercharger assembly 100″ is essentially the same as supercharger assembly 100, except that it further includes a bypass duct 190. In addition, the intake duct 126′ and transition duct 124′ have been modified to allow intake air stream 150 to flow either as a stream 150a though the ejector pump 122 or as a stream 150b through the bypass duct 190. Furthermore, the bypass duct 190 includes a bypass valve 188 that prevents a back flow through the bypass duct. During naturally aspirated operation of the ICE 20, the bypass valve 188 is in open position and the ICE draws intake air stream 150 through the intake duct 126′ into the bypass duct 190, and through the transition duct 124′ into ICE intake passage (not shown). A smaller portion of the intake air flow may also pass through the ejector pump 122. During supercharging, the bypass valve 188 is closed and the ejector pump 122 is operated in already described manner. Those skilled in the art will appreciate that the cross-section of the bypass duct 190 can be made arbitrarily large and thus offering low impedance to air flowing therethrough. As a result, the supercharger assembly 100″ offers low air flow impedance under naturally aspirated ICE operation which translates to a higher ICE charge pressure. Preferably, the bypass valve 188 is formed as a check valve that closes automatically whenever the pressure in the transition duct 126′ exceeds the pressure in the intake duct 124′ by a predetermined amount. Alternatively, the bypass valve 188 is an actuated valve of a suitable type (e.g., gate valve, poppet valve, damper valve, or a butterfly valve) operated by the ICE control unit. For example, the ECU can close the bypass valve 188 when the mass flow through driving nozzle 140 exceeds a predetermined mass flow value. Alternatively, the by-pass valve 188 can be arranged to close when the pressure in the transition duct 124′ exceeds the pressure in the intake duct 126′ by a predetermined amount. If the valve 188 is an actuated valve, its closing and opening rate can be coordinated with the value of mass flow rate of air through nozzle 140 to produce a substantially smooth variation in air pressure at discharge port 198. This approach avoids undesirably abrupt changes in supercharger output air pressure (as sensed, for example by pressure sensor 158 in transition duct 124) and consequential abrupt changes in ICE power output. Suitably precise control of valve 188 can be accomplished, for example, by actuating the valve 188 by a stepping motor.

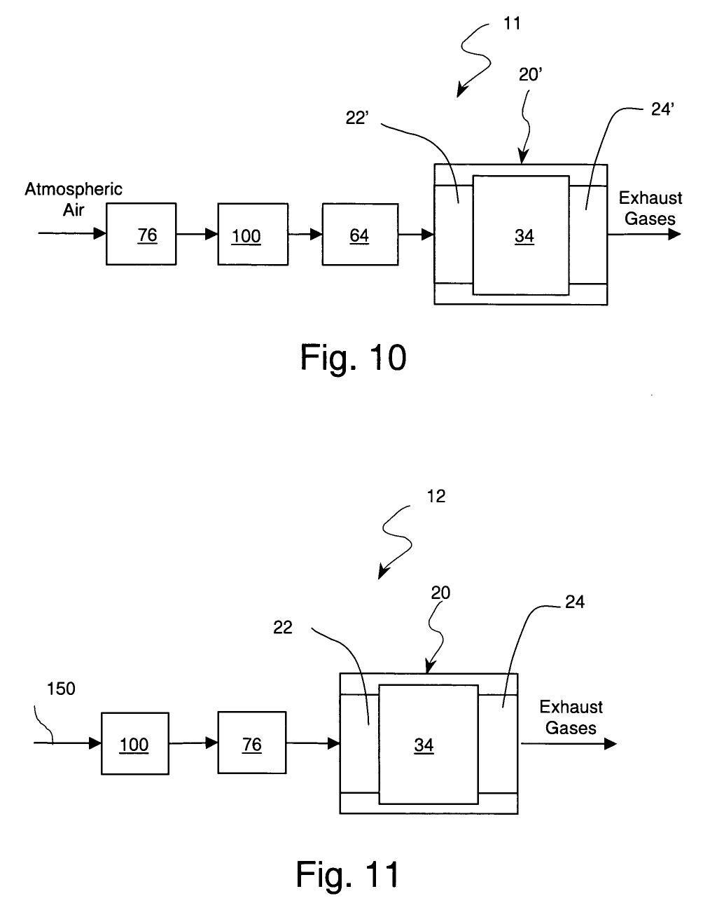

As already stated, the ICE system 10 shown in FIG. 4 is particularly suited for compression ignition (i.e., diesel type) ICE, fuel injected spark ignition ICE and HCCI type ICE. In a compression ignition ICE, fuel is injected directly into the combustion chamber of ICE 20. In a fuel injected spark ignition ICE, fuel is injected either into the intake passage 22 or directly into the combustion chamber. In both of these ICE types, the gas flowing though the supercharger 100 (and each of its variants 100′ and 100″) is intake air. However, the supercharger assembly 100 (and each of its variants 100′ and 100″) can be also used to supercharge carbureted spark ignition engines. Referring now to FIG. 10 there is shown an ICE system 11 in accordance with a second embodiment of the present invention including a carbureted spark ignition engine 20′, carburetor 64, air filter 76, and a supercharger assembly 100. Those skilled in the art will appreciate that supercharger assembly 100 could also be also used in its first variant form 100′ or second variant form 100″. Supercharger 100 receives ambient air via air filter 76. Air discharged by the supercharger 100 is then fed into the intake passage 22′ of ICE 20′ via the carburetor 64.

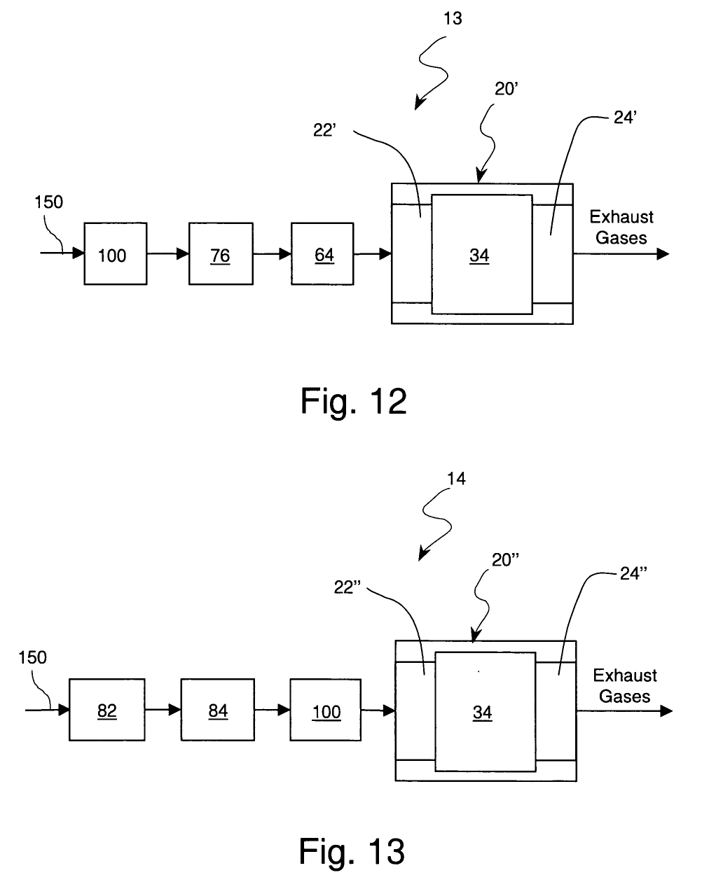

The supercharger assembly 100 (and each of its variants 100′ and 100″) can be also used to retrofit existing compression ignition (diesel) ICE as well as carbureted ICE and fuel injected spark ignition ICE. In particular, to retrofit an existing ICE, the supercharger 100 can be placed upstream of an existing air filter. Referring now to FIG. 11 there is shown an ICE system 12 in accordance with a third embodiment of the present invention including an ICE 20 which can be either compression ignition type or fuel injected spark ignition type, air filter 76, and a supercharger assembly 100. Intake air stream 150 is drawn into the supercharger assembly 100, is pumped by it and fed into the intake passage 22′ via air filter 76. Referring now to FIG. 12 there is shown an ICE system 13 in accordance with the fourth embodiment of the present invention including a carbureted spark ignition ICE 20′, carburetor 64, air filter 76, and a supercharger assembly 100. Intake air stream 150 is drawn into the supercharger assembly 100, is pumped by it and fed into the intake passage 22′ via air filter 76 and carburetor 64.

The supercharger assembly 100 (and each of its variants 100′ and 100″) can be also used with conventional engine-driven superchargers and conventional turbochargers to augment their performance at low engine speed. As already noted, during the conditions of high torque and low rotational engine speeds, a conventional supercharger alone is unable to effectively supercharge the engine. This condition can be mitigated by using the supercharger assembly 100 of the present invention to function as a booster stage for a conventional supercharger. Referring now to FIG. 13 there is shown an ICE system 14 in accordance with a fifth embodiment of the present invention comprising an ICE 20″ having an intake passage 22″ which is fed intake air by the supercharger assembly 100 which, in turn receives intake air from a conventional supercharger 82. An intercooler 84 is preferably included between the supercharger 82 and the supercharger assembly 100. The ICE 20″ can be either a compression ignition type, spark ignition type, or HCCI type. The conventional supercharger 82 can be an engine-driven supercharger or a turbocharger. The supercharger assembly 100 can be also used in its variant form 100′ or 100″. Intake air 150 is compressed by the supercharger 82, cooled by the intercooler 84, and pumped by supercharger assembly 100 into the intake passage 22. When supercharging of the ICE 20″ is desired, the supercharger assembly 100 is activated by flowing high-pressure air through driving nozzle 140 (FIG. 4) at a predetermined flow rate to supercharge ICE 20″ for initial period of time. As the rotational speed of ICE 20″ increases during this initial period, the conventional supercharger 82 gradually becomes more effective at compressing intake air, thereby reducing the need for the boosting effect provided by supercharger assembly 100. In view of this, flow rate of high-pressure air through driving nozzle 140 can be appropriately reduced and, when predetermined conditions are reached, the operation of supercharger assembly 100 is discontinued. There are numerous variants to using the subject invention with conventional engine-driven superchargers and turbochargers. For example, the supercharger 100 can be placed upstream of the conventional supercharger 82 rather than downstream as shown in FIG. 13. In another alternative embodiment of the present invention the supercharger assembly 100 is connected in parallel to the conventional supercharger 82, and control valves are used to arbitrate intake air flow depending on engine rotational speed and load conditions. In yet another alternative embodiment of the subject invention, the supercharger 82 is an ejector pump.

The advantage of using a combination of the conventional supercharger 82 and the supercharger assembly 100 is that the performance of the overall ICE system 14 is improved since the supercharger assembly 100 provides improved supercharging performance during the conditions of high torque and low engine speeds (e.g., during automotive vehicle acceleration from a stopped condition), whereas the conventional supercharger 82 provides improved supercharging performance during the conditions of high torque and moderate to high engine speeds, especially when such conditions last for a longer period of time (for example, during extended grade ascent or passing).

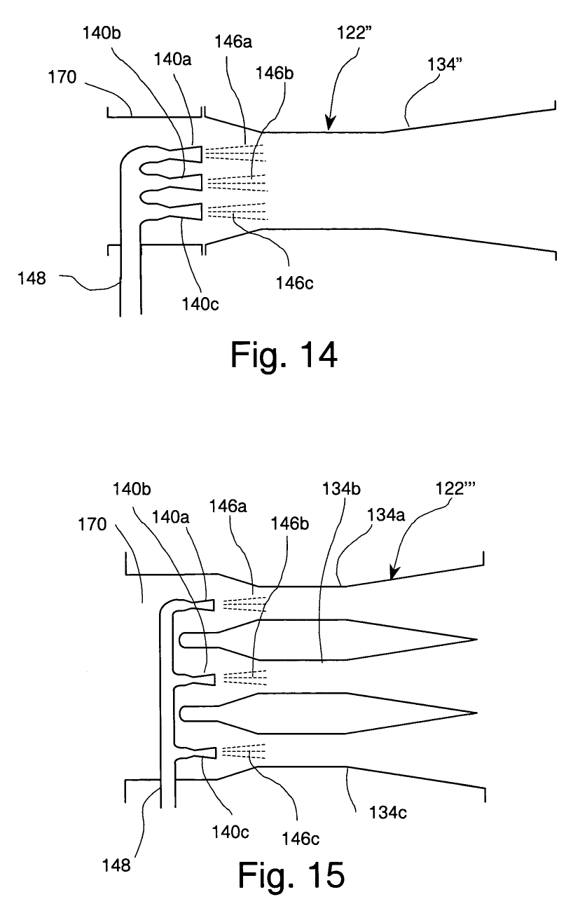

The ejector pump used in the subject invention can have multiple driving nozzles injecting high-velocity jet into a single diffuser duct. FIG. 14 shows an ejector pump 122″ wherein three driving nozzles 140a, 140b, and 140c inject high-velocity jets 146a, 146b, and 146c into a single diffuser duct 134′. This configuration reduces the overall length of the ejector pump. Alternatively, several ejectors can be used in parallel. In particular, FIG. 15 shows ejector pump 122′″ having nozzles 140a, 140b, and 140c respectively injecting jets 146a, 146b, and 146c into respective diffusers 134a, 134b, and 134c. The configuration shown in FIGS. 14 and 15 permit constructing comparably shorter ejector pumps and they are particularly suitable for installing the supercharger assembly of the subject invention into intake air ducts when retrofitting an existing ICE system.

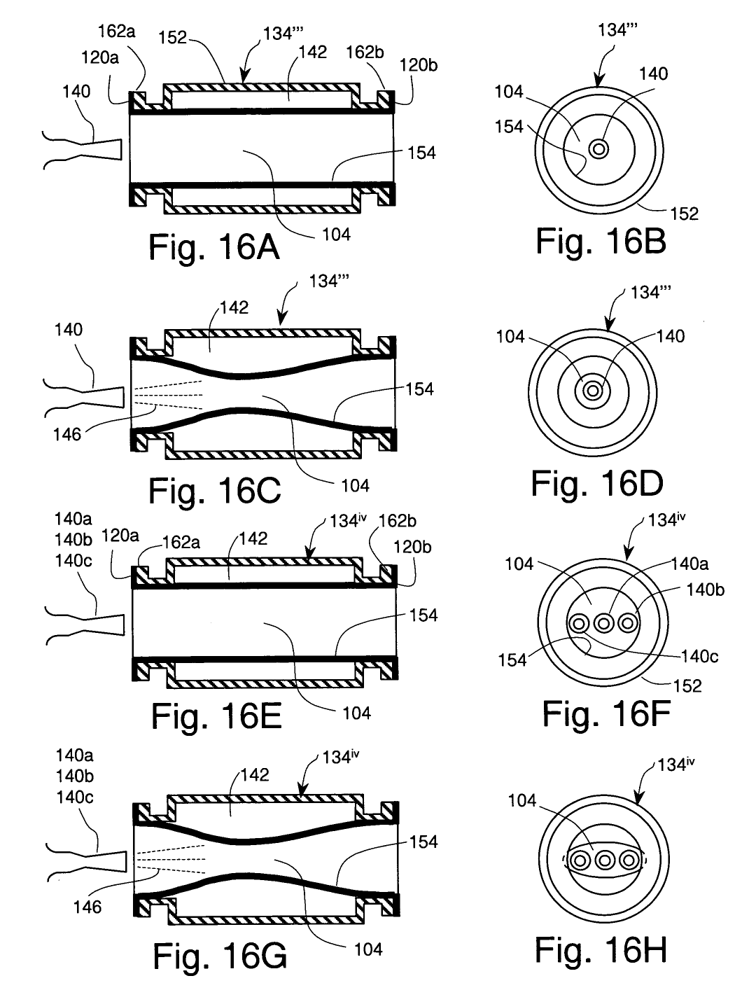

The diffuser 134 can be also constructed with a variable area throat. Variable throat area diffuser is particularly useful for practicing with the first embodiment of the invention (FIG. 4) because it offers reduced intake air impedance when the ICE operates with normal aspiration (non-supercharged). FIGS. 16A through 16D show a variable throat area diffuser 134′″ comprising a housing 152 and an elastic duct 154. The housing 152 is a rigid generally tubular body having flanges 162a and 162b. The housing 152 is preferably constructed from metal, plastic, or composite materials. The elastic duct 154 is a tubular member having a generally circular cross-section and end flanges 120a and 120b. The outside diameter of elastic duct 154 is sized to fit inside the housing 152. The wall thickness of elastic duct 154 is typically between about 0.010 inches (0.25 millimeter) and about 0.1 inches (2.5 millimeters). It should be noted that the thickness of the wall of the elastic duct 154 can be varied along the axis of the duct to influence its deformed shape. Preferred materials suitable for construction of the elastic duct 154 include elastomers such as various types of rubber, urethane, polyurethane, or alike. The elastic duct 154 is installed inside the housing 152 with the flanges 120a and 120b placed over the flanges 162a and 162b respectively. When the diffuser duct 134′″ is connected with flanged ducts upstream and downstream, the flanges 120a and 120b are compressed and held in place. Alternative means for holding flanges 120a and 120b in place include mechanical clamps and adhesives. If the elastic duct 154 is made of rubber or rubber-like material, flanges 120a and 120b can be attached by vulcanizing directly onto flanges 162a and 162b respectively. The ejector duct 134′″ further includes means (not shown) for deforming the elastic duct 154 to reduce the area of the throat 104. Such means, which can be mechanical, hydraulic, or pneumatic are well known in the art of fluid valves and have been employed to vary the throat of elastic tubes. Suitable mechanical means for deforming the elastic duct 154 have been disclosed, for example, by Buffum in the U.S. Pat. No. 1,108,010, Swindin in the U.S. Pat. No. 2,516,029, and Carlson in the U.S. Pat. No. 4,092,010. Suitable pneumatic and hydraulic means are employed in pinch valves manufactured by Red Valve Company, Carnegie, Pa. To implement the hydraulic or pneumatic means, the cavity 142 (FIGS. 16A and 16C) can be filled with a suitable working fluid which can be provided in a form of gas, liquid, or gel. Preferred selection of working fluid includes air, ICE coolant liquid, hydraulic fluid, and silicon gel. By appropriately increasing the pressure of the working fluid the elastic duct 154 can be deformed so as to reduce the area of throat 104.

Referring now to FIG. 16A, there is shown a cross-section of a diffuser duct 134′″ with elastic duct 154 in an undistorted condition and having a throat 104 with a larger area. This condition of elastic duct 154 is suitable for passing intake air through the diffuser 134′″ during normal (non-supercharged) aspiration of the ICE. FIG. 16B shows the end view of the diffuser duct 134′″ depicted in FIG. 16A looking upstream. When supercharging, driving nozzle 140 injects a high-velocity air jet 146 into the diffuser 134′″. To produce efficient pumping action by the jet 146, the internal dimensions and shape of the diffuser should conform to a generally convergent-divergent nozzle as represented, for example, by diffuser 134 shown in FIG. 4. To accomplish this, the elastic duct 154 is deformed to reduce the area of throat 104. This condition of elastic duct 154 which is shown in FIG. 16C is used for supercharging. FIG. 16D shows the end view of the diffuser duct 134′″ depicted in FIG. 16C looking upstream and revealing that the reduced area throat 104 has a generally circular shape. FIGS. 16E through 16H show a diffuser duct 134^{iv} which is a variant of the diffuser duct 134′″. The diffuser duct 134^{iv} is generally the same as the diffuser duct 134′″ except that the elastic duct 154 can be distorted into a generally oval shape (FIG. 16H). This variant of the diffuser duct can be advantageously used With multiple driving nozzles. In particular, FIGS. 16E and 16F show nozzles 140a, 140b, and 140c arranged to inject driving air into the throat 104.

In another variant of the instant invention, compressed air supplied to the driving nozzle 140 is heated to above ambient temperature. Using hot driving air improves ejector performance and prevents formation of ice in the driving nozzle. In particular, air supplied to driving nozzle 140 can be heated in a heat exchanger which receives heat from the ICE coolant, ICE lubricant, or ICE exhaust gases.

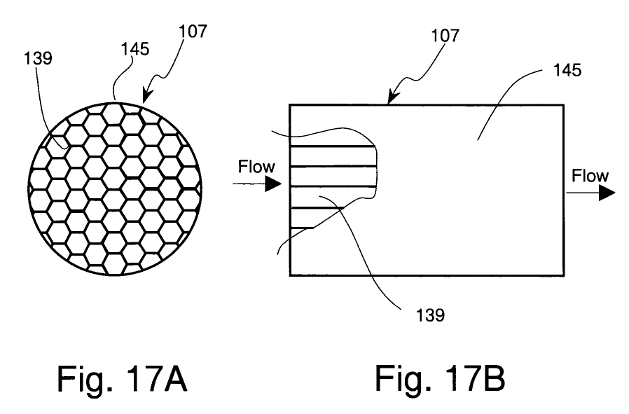

Supersonic ejector pump 122 discharges an air flow having a considerable turbulence. Excessive turbulence in intake air can compromise proper operation of devices such as throttle, fuel injector, and carburetor which may be located downstream of the ejector pump 122. Turbulence in the air discharged by the ejector pump 122 can be reduced by installing a turbulence reducing device in the transition duct 124. Suitable turbulence reducing devices include one or more screens or perforated plates installed generally perpendicular to the direction of bulk flow. Alternative turbulence device can be configured as an array of generally parallel flow channels having a small hydraulic diameter. FIGS. 17A and 17B show respectively the end view and the side view of a turbulence reducing device 107 comprising a shell 145 containing an array of flow tubes 139 having hexagonal cross-section and arranged in a honeycomb-like pattern. While flow tubes 139 with hexagonal cross-section are conducive to good stacking, tubes having alternative cross-sections including circular, oval, square, rectangular or triangular can be also used. Preferably, flow tubes 139 have very thin walls and very smooth internal surfaces. Preferred size of the flow tube hydraulic diameter is between 1 and 5 millimeters (0.04 and 0.2 inches). Preferred length of the flow tubes 139 is between 10 and 100 times the flow tube hydraulic diameter. The turbulence reducing device 107 can be also conveniently formed from honeycomb made of metal, plastic, or other suitable material. The turbulence reducing device can also function as an intercooler by removing heat from the intake air and storing it in the thermal inertial of its structure.

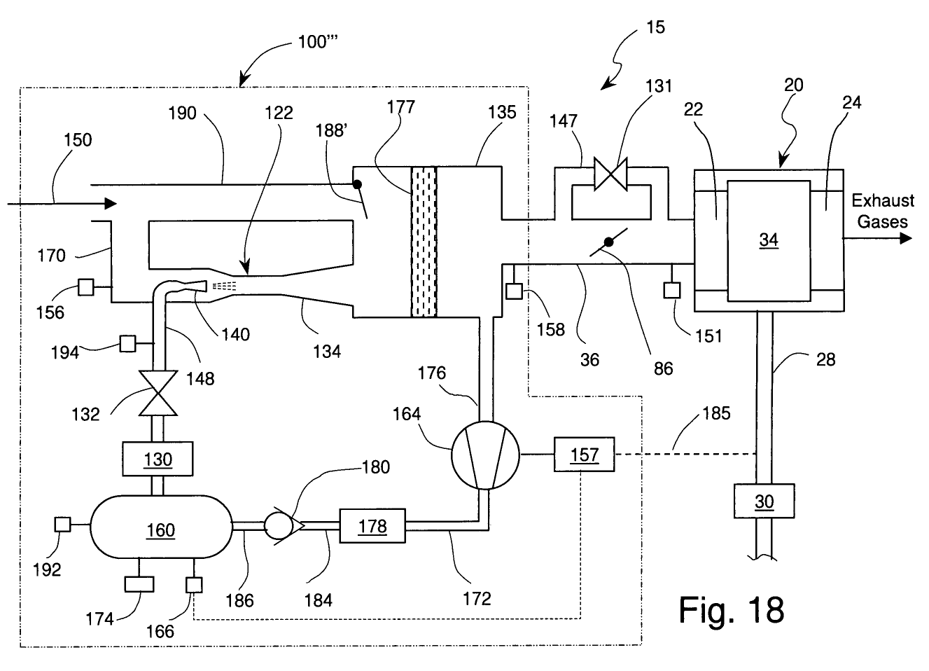

Referring now to FIG. 18 there is shown a supercharged ICE system 15 in accordance with a sixth embodiment of the subject invention. The ICE system 15 comprises a supercharger assembly 100′″ fluidly connected to an ICE 20 by an intake duct 36. The supercharger assembly 100′″ is essentially the same as supercharger assembly 100′ except that it further includes a bypass duct 190 and an air filter housing 135 containing an air filter 177. The bypass duct 190 is configured to flow intake air through a bypass valve 188′ into the air filter housing 135 to a location upstream of the air filter 177. The ejector pump 122 is configured to discharge air into the air filter housing 135 to a location upstream of the air filter 177. A downstream part of air filter housing 135 is fluidly coupled to the intake air duct 36 and to line 176 leading to the intake of compressor 164. The compressor 164 is mechanically coupled to ICE output shaft 28 by an on/off clutch 157 and a mechanical drive 185. The on/off clutch 157 is preferably mounted onto the drive shaft of compressor 164. The mechanical drive 185 is preferably a shaft, a coupling, and/or a system of gears, and/or a system of pulleys and belt. If the supercharger assembly 100′″ is retrofitted onto an existing ICE system, the on/off clutch 157 preferably has a pulley which can be driven from an existing ICE system of belts and pulleys operated by the ICE drive shaft 28. The pressure switch 166 is wired to control the clutch 157 to maintain the pressure inside the air tank 160 within predetermined limits. The bypass valve 188′ is preferably configured as a check valve or a damper valve which automatically closes when the pressure inside the air filter housing 135 exceeds the pressure inside the bypass duct 190 by a predetermined amount and automatically opens otherwise. Alternatively, valve 188′ is operated by an actuator. If the valve 188′ is an actuated valve, its closing and opening rate can be coordinated with the value of mass flow rate of air through nozzle 140 to produce substantially smooth variation in air pressure at discharge port 198 sensed, for example, by sensor 158. This approach prevents undesirably abrupt changes in supercharger output pressure and consequential abrupt changes in ICE power output. Suitably precise control of valve 188′ can be accomplished, for example, by operating valve 188′ by a stepping motor. An intercooler (not shown) can be installed into the air filter housing 135 preferably down stream of the air filter 177. Preferably, the intercooler rejects at least a fraction of the heat contained in intake air into intercooler structure and/or PCM as already described in connection with the first embodiment. The sixth embodiment of the instant invention may result from (but is not limited to) retrofitting an existing automotive ICE system with the supercharger assembly 100′″.

When the ICE system 15 operates in a naturally aspirated mode, intake air stream 150 enters the supercharger assembly 100′″ where it flows through the bypass duct 190 and bypass valve 188′ into the air filter housing 135 where dust and particulates are removed by the air filter 177. Intake air free of dust and particulates then flows through the intake air duct 36 into the intake passage 22 of ICE 20. When the compressor 164 is operated, a small portion of the filtered intake air is drawn from the air filter housing 135 through line 176 and provided to the intake of compressor 164 where it is compressed and delivered to air tank 160 in a manner already described in connection with the supercharger assembly 100′. When the ICE system 15 operates in a supercharged mode in response to a power demand, the pressure regulator 130 is appropriately set and the on/off valve 132 opens to flow high-pressure air from air tank 160 to driving nozzle 140, thereby producing a pumping action in the ejector pump 122. Intake air stream 150 enters the supercharger assembly 100′″ and flows into the ejector pump 122 which pumps it into the air filter housing 135. The resulting overpressure in air filter housing 135 closes the bypass valve 188′. Alternatively, valve 188′ is operated by an actuator and its closing and opening action is coordinated with the value of air mass flow rate through nozzle 140 to produce substantially smooth changes in air pressure in intake passage 22. The intake air discharged by ejector pump 122 is filtered and provided through intake air duct 36 to ICE 20 in an already described manner.

While improvements in ICE performance are desirable, it is also important for an ICE to comply with existing emissions requirements. One way in which emissions are reduced to acceptable levels is through the use of exhaust gas recirculation (EGR) wherein a conduit connects the ICE exhaust passage to the intake passage to allow exhaust gas to be recycled through the combustion chamber. In this manner, exhaust species are reintroduced to the engine, lowering NOₓ emissions levels by lowering flame temperature. If it is desirable to use EGR with the present invention, it can be accomplished preferably by connecting one end of EGR conduit to the exhaust passage 24 and the other end to the suction chamber 170 of the ejector pump 122. As a result, the EGR receives exhaust gasses from the exhaust passage 24 and conveys them to the suction chamber 170 to be pumped by the ejector pump 122 back into ICE 20. Hence the term “intake air” used in this application should be give an broad interpretation so as to include presence of exhaust gases.

The supercharger 100 of the subject invention can be also used to reduce ICE emissions during cold engine start. Automotive vehicles with spark-ignition ICE typically have an exhaust system which includes a catalytic converter that reduces hazardous exhaust emissions. However, during the period immediately after a cold engine start until the time the catalytic converter reaches the catalyst activation temperature, a large quantity of hazardous emissions are discharged into the atmosphere without being adequately converted. According to some estimates, about 90% of hazardous emissions from vehicles equipped with catalytic converters are discharged during this period. It is well known in the art that the time necessary for bringing the catalytic converter to activation temperature can be greatly reduced by increasing the quantity of ICE intake air and/or by retarding the ignition timing. See, for example, M. Ueano et al., in “A Quick Warm-Up System During Engine Start-Up Period Using Adaptive Control of Intake Air and Ignition Timing,” SAE paper number 2000-01-0551, published by the already noted Society of Automotive Engineers. To reduce emissions during cold start period the supercharged ICE of the subject invention can be operated as follows: the supercharger 100 (and any of its variants 100′, 100″, and 100′″) is activated immediately after the cold engine start event and the ICE is supercharged for a predetermined time or until the exhaust gas catalyst reaches a predetermined temperature. In particular, when the control unit detects that the catalyst temperature is less than a predetermined value, the regulator 130 is set and valve 134 is opened to flow a predetermined amount of air through nozzle 140. Concurrently the ICE ignition timing can be retarded. Preferred ignition timing retardation range is between 0 and 30 degrees.

During cold start period and idle engine condition the throttle valve is typically essentially closed. Unless there is a provision to open the throttle to provide more intake air flow to the engine, the air delivered by the supercharger during cold ICE start must bypass the throttle. To make this possible, ICE system 15 (FIG. 18) can include a throttle bypass conduit 147 with a throttle bypass valve 131 connected to intake air duct 36 for the purpose of bypassing throttle 86. During normal operation of ICE 20 (normally aspirated or supercharged) the valve 131 is closed and throttle 86 is used to regulate intake air flow for ICE 20 in a usual manner. During cold engine start period, the valve 131 is opened and supercharger assembly 100′″ operated to supercharge the ICE 20. Air delivered by the supercharger 100′″ bypasses the throttle 86 by flowing through the throttle bypass conduit 147 and throttle bypass valve 131. As a result, pressure in the intake passage increases. ICE fuel flow rate can be increased correspondingly to obtain desired air-to-fuel ratio. In addition to supercharging, the ignition timing of ICE 20 can be retarded preferably by as much as 30 degrees from top dead center (TDC) of the piston stroke to expedite the warm-up of the exhaust gas catalytic converter (nor shown). The flow through nozzle 140 is terminated after a predetermined time period has lapsed or after the catalyst has reached a predetermined temperature. Typical time for the catalyst to reach activation temperature is about 10 to 20 seconds. To further limit exhaust emissions during this period, a portion of the exhaust gas stream can be recirculated by feeding it into the suction chamber 170 of ejector pump 122. Once the catalytic converter reaches predetermined temperature, the supercharging can be discontinued and throttle bypass valve 131 can be closed. It is well known in the art that injection of air upstream of the catalytic converter allows improved combustion of unburned hydrocarbons exhausted from the combustion chamber during a cold start. The supercharger 100′″ can adapted for this service by providing a line (not shown) from the air tank 160 the exhaust path of ICE 20 upstream of the catalytic converter. The line should include a metering orifice and a control valve which opens during an ICE cold start.

It will be appreciated that the present invention can be implemented with a variety of ICE of either reciprocating type or rotary type. The ICE can have any number of combustion chambers. Features of the various embodiments can be combined in any manner. As already noted, the driving nozzle 140 in any of the embodiments is a supersonic nozzle preferably implemented as a convergent-divergent nozzle also known as the Laval nozzle. The Laval nozzle can be implemented as 1 dimensional (slit nozzle) or 2 dimensional (“bell” nozzle). Alternate supersonic nozzle types include the plug nozzle, spike nozzle, annular nozzle, and expansion-deflection nozzle. The term “intake air” used in this application should be give an broad interpretation so as to include presence of ICE fuel and ICE exhaust gases. Thus, intake air is essentially a mixture of nitrogen, oxygen, carbon dioxide, water vapor, and inert gases, and may also include ICE fuel vapor, nitrogen oxides, and hydrocarbons. Because some embodiments of the invention the high-pressure air for operation of the ejector nozzle may be derived from the intake air, the composition of the high-pressure air may be essentially same as that of the intake air.

A variety of conventional components can be used for construction of the present invention. Examples of suitable intercoolers 168 for use in the transition duct 124 include, without limitation, shell and tube type intercoolers and fin and plate type intercoolers. Some examples of suitable bypass valves 188 for use in the bypass duct 190 include one-way valve, check valve, damper valve, actuated valve, poppet-type valve, and butterfly-type valve. Suitable ICE torque sensor includes the Torkdisk™ manufactured by Piezotronics in Depew, N.Y. As mentioned above, any conventional supercharger and EGR components can be used in combination with the supercharger assembly 100. The supercharger 82 can be a single stage supercharger, a compound supercharger, a series supercharger, or any other type of supercharger. The supercharger 82 can be formed as a turbocharger or an engine-driven supercharger. Suitable engine-driven superchargers include Roots pump, vane pump, and screw compressor.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

Moreover, terms that are expressed as “means-plus function” in the claims should include any structure that can be utilized to carry out the function of that part of the present invention. In addition, the term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the present invention as defined in the appended claims. Furthermore, the foregoing description of the embodiments according to the present invention are provided for illustration only, and not for the purpose of limiting the present invention as defined by the appended claims and their equivalents. Thus, the scope of the present invention is not limited to the disclosed embodiments.

What is claimed is:

1. A supercharged internal combustion engine system comprising:
an internal combustion engine (ICE) and an ejector pump for supercharging said ICE;
said internal combustion engine having at least one combustion chamber and an intake passage;
said intake passage being fluidly coupled to said combustion chamber and configured for flowing intake air thereinto;
said ejector pump having at least one supersonic driving nozzle, a suction port, and a discharge port;
said driving nozzle being fluidly coupled to a source of high-pressure air;
said suction port being fluidly coupled to a source of intake air;
said discharge port being fluidly coupled to said intake passage.

2. An ICE system as in claim 1 wherein said ICE is chosen from the group consisting of a compression ignition engine, carbureted spark ignition engine, fuel injected spark ignition engine, HCCI engine, reciprocating engine and a rotary engine.

3. An ICE system as in claim 1 wherein said supersonic driving nozzle is chosen from the group consisting of a Laval nozzle, convergent-divergent nozzle, plug nozzle, spike nozzle, annular nozzle, and expansion-deflection nozzle.

4. An ICE system as in claim 1 further comprising a flow control means for regulating a mass flow rate of said high-pressure air through said driving nozzle.

5. An ICE system as in claim 4 wherein said flow control means is suitable for substantially smooth variation of said mass flow rate of said high-pressure air.

6. An ICE system as in claim 4 wherein said flow control means is chosen from the group consisting of a valve, control valve, actuated control valve, needle valve, metering valve, poppet-type valve, plug valve, pressure regulator, pressure reducing regulator, and a variable area nozzle.

7. An ICE system as in claim 1 further comprising a means for determining at least one ICE operating parameter selected from the group consisting of ICE output torque value, ICE demand torque value, ICE output power value, and ICE demand power value.

8. An ICE system as in claim 4 further comprising a electronic control unit (ECU) operatively coupled to said flow control means for regulating mass flow rate through said driving nozzle according to operating conditions of said ICE.

9. An ICE system as in claim 8, wherein said ECU is configured to increase said mass flow rate when a first operating condition is met; said first operating condition is chosen from the group consisting of: 1) engine rotational speed is less than a predetermined engine rotational speed value and engine output torque is more than a predetermined engine output torque value, 2) engine rotational speed is less than a predetermined engine rotational speed value and engine fuel flow is more than a predetermined fuel flow value, 3) the difference between the demand torque value and engine output torque value is more than a predetermined torque difference value, 4) the difference between the demand power value and engine output power value is more than a predetermined power difference value, and 5) the difference between the supercharger output air pressure value required to meet power demand and the measured supercharger output air pressure value is more than a predetermined pressure difference value.

10. An ICE system as in claim 8, wherein said control unit is configured to decrease said mass flow rate when a second operating condition is met; said second operating condition is chosen from the group consisting of: 1) engine rotational speed is more than a predetermined engine rotational speed value and engine output torque is less than a predetermined engine output torque value, 2) engine rotational speed is more than a predetermined engine rotational speed value and engine fuel flow is less than a predetermined fuel flow value, 3) the difference between the engine output torque value and demand torque value is more than a predetermined torque difference value, 4) the difference between the engine output power value and demand power value is more than a predetermined power difference value, and 5) the difference between the measured supercharger output air pressure value and the supercharger output air pressure value required to meet power demand is more than a predetermined pressure difference value.

11. An ICE system as in claim 8 wherein said ECU regulates said mass flow rate through said driving nozzle according to parameters chosen from the group consisting of engine output power, engine demand power, engine output shaft torque, engine demand torque, engine rotational speed, intake passage pressure, air mass flow rate, combustion chamber pressure, spark timing, fuel flow rate, vehicle speed, and position of accelerator pedal.

12. An ICE system as in claim 1 further comprising a transition duct and an intercooler; wherein said transition duct fluidly couples said discharge port to said intake passage; said intercooler is located in said transition duct for cooling of intake air discharged by said ejector pump; and said intercooler is adapted to rejecting heat from said intake air into a medium chosen from the group consisting of an ICE coolant, ambient air, intercooler structure, and phase change material (PCM).

13. An ICE system as in claim 1 further comprising an ejector bypass duct and a bypass valve; said ejector bypass duct having an inlet fluidly coupled to said suction port and an outlet fluidly coupled to said intake passage; and said bypass valve being adapted for controlling air flow through said bypass duct.

14. An ICE system as in claim 13 wherein said bypass valve is arranged to be closed when mass flow rate of said high-pressure air to said driving nozzle is more than a predetermined mass flow rate value and to be open when mass flow rate of said high-pressure air to said driving nozzle is less than a predetermined mass flow rate value.

15. An ICE system as in claim 13 wherein said bypass valve is arranged to be closed when the difference between the air pressure in said intake passage and the air pressure at said suction port is more than a predetermined pressure value, and to be open when the difference between the air pressure in said intake passage and the air pressure at said suction port is less than a predetermined pressure value.

16. An ICE system as in claim 13 wherein at least one of the closing speed and the opening speed of said bypass valve are controlled to produce substantially smooth variation in air pressure in said ejector pump discharge port.

17. An ICE system as in claim 13 wherein said bypass valve is chosen from the group consisting of an automatic check valve, actuated valve, butterfly valve, valve actuated by a stepping motor, and a damper valve.

18. An ICE system as in claim 1 wherein said ejector pump further comprises a diffuser; said diffuser duct having a first end and a second end; said first end of said diffuser duct fluidly coupled to said suction chamber; said second end of said diffuser duct fluidly coupled to said intake passage; and said driving nozzle discharging flow into said first end.

19. An ICE system as in claim 18 wherein said diffuser has a variable throat area; said throat area is arranged to decrease when the mass flow of said high-pressure air through said driving nozzle is more than a predetermined high-pressure air mass flow value, and said throat area is arranged to increase when the mass flow of said high-pressure air through said driving nozzle is less than a predetermined high-pressure air mass flow value.

20. An ICE system as in claim 1 further comprising a turbulence reducing device receiving flow from said discharge port.

21. An ICE system as in claim 1 wherein said source of high-pressure air comprises an air compressor, an air tank, and controls for maintaining the pressure of said high-pressure air inside said air tank within predetermined limits; said air compressor having an inlet and outlet; said air compressor inlet configured to admit atmospheric air; said air compressor outlet fluidly coupled to said air tank; said air tank fluidly coupled to said driving nozzle.

22. An ICE system as in claim 21 wherein said air compressor is chosen from the group consisting of a compressor driven by an electric motor, compressor driven by ICE output shaft, compressor driven by a vehicle power train, compressor with an on/off clutch, compressor with an unloader valve, piston compressor, positive displacement reciprocating compressor, vane compressor, scroll compressor, diaphragm compressor, and screw compressor.

23. An ICE system as in claim 21 wherein said air tank is of composite construction.

24. An ICE system as in claim 21 further including an exhaust passage fluidly coupled to said combustion chamber, a catalytic converter fluidly coupled to said exhaust passage, and a conduit fluidly connecting said air tank to said exhaust passage.

25. An ICE system as in claim 1 wherein said source of intake air is chosen from the group consisting of atmospheric air, an engine-driven supercharger and a turbocharger.

26. An ICE system as in claim 1 wherein said suction port is fluidly coupled to an exhaust port of a supercharger chosen from the group consisting of an engine-driven supercharger and a turbocharger.

27. An ICE system as in claim 1 further comprising a supercharger disposed between said discharge port of said ejector pump and said intake passage of said ICE; said supercharger having a supercharger inlet and a supercharger outlet; said supercharger inlet connected to said discharge port of said ejector pump; said supercharger outlet connected to said intake passage of said ICE; said supercharger chosen from the group consisting of an engine-driven supercharger, turbocharger and ejector pump.

28. An ICE system as in claim 1 further including an exhaust passage fluidly coupled to said combustion chamber, a catalytic converter fluidly coupled to said exhaust passage, a throttle installed downstream of said discharge port, a throttle bypass conduit for bypassing said throttle, and a throttle bypass valve installed in said throttle bypass conduit for controlling air flow therethrough; said throttle bypass valve is arranged to be in an open position when the temperature of said catalytic converter is less than a predetermined catalytic converter temperature value and said throttle bypass valve is arranged to be in a closed position when the temperature of said catalytic converter is more than a predetermined catalytic converter temperature value.

29. An ICE system as in claim 28 wherein said mass flow rate through said driving nozzle is increased when the temperature of said catalytic converter is less than a predetermined catalytic converter temperature value and said mass flow rate through said driving nozzle is decreased when the temperature of said catalytic converter is more than a predetermined catalytic converter temperature value.

30. An ICE system as in claim 28 wherein spark ignition timing is retarded when the temperature of said catalytic converter is less than a predetermined catalytic converter temperature value.

31. An ICE system as in claim 1 further comprising an exhaust passage and an exhaust gas recirculation (EGR) conduit; said exhaust passage fluidly coupled to said combustion chamber for passing combustion products therefrom; said (EGR) conduit having an EGR inlet fluidly coupled to said exhaust passage and an EGR outlet fluidly coupled to said suction port of said ejector pump.

32. An ICE system as in claim 1 further comprising a means for heating high pressure air from said high-pressure source prior to flowing said high pressure air to said driving nozzle.

33. A supercharged internal combustion engine system comprising:
(a) an internal combustion engine (ICE) having at least one combustion chamber, an intake passage, and an exhaust passage; said intake passage configured for flowing intake air to said combustion chamber; said exhaust passage configured for flowing combustion products from said combustion chamber; said ICE is chosen from the group consisting of a compression ignition engine, carbureted spark ignition engine, fuel injected spark ignition engine, HCCI engine, reciprocating engine and rotary engine;
(b) an ejector pump for supercharging said ICE; said ejector pump having a driving nozzle, a suction port, and a discharge port; said ejector pump configured to receive intake air through said suction port and discharge pressurized intake air through said discharge port;
i) said driving nozzle being fluidly coupled to a source of high-pressure air for admitting high-pressure air therefrom;
ii) said suction port being fluidly coupled to a source of said intake air to receive said intake air therefrom;
iii) said discharge port being fluidly coupled to said intake passage to discharge said pressurized intake air thereto;
(c) a means for sensing ICE power demand; and
(d) a flow control means suitable for substantially smoothly varying the mass flow rate of said high-pressure air through said driving nozzle.

34. An ICE system as in claim 33 further comprising an electronic control unit (ECU) operatively coupled to said flow control means; said ECU being configured to increase said mass flow rate when a first operating condition is met, and to decrease said mass flow rate when a second operating condion is met;
said first operating condition is chosen from the group consisting of:
1) engine rotational speed is less than a predetermined engine rotational speed value and engine output torque is more than a predetermined engine output torque value,
2) engine rotational speed is less than a predetermined engine rotational speed value and engine fuel flow is more than a predetermined fuel flow value, and
3) the difference between the demand torque value and engine output torque value is more than a predetermined torque difference value,
4) the difference between the demand power value and engine output power value is more than a predetermined power difference value, and
5) the difference between the supercharger output air pressure value required to meet demanded power and the measured supercharger output air pressure value is more than a predetermined pressure difference value;
said second operating condition is chosen from the group consisting of:
1) engine rotational speed is more than a predetermined engine rotational speed value and engine output torque is less than a predetermined engine output torque value,
2) engine rotational speed is more than a predetermined engine rotational speed value and engine fuel flow is less than a predetermined fuel flow value,
3) the difference between the engine output torque value and demand torque value is less more a predetermined torque difference value,
4) the difference between the engine output power value and demand power value is more than a predetermined power difference value, and
5) the difference between the measured supercharger output air pressure value and the supercharger output air pressure value required to meet demanded power is more than a predetermined pressure difference value.

35. An ICE system as in claim 33 further comprising a electronic control unit (ECU) operatively coupled to said flow control means, and a catalytic converter including a catalyst; said control unit being configured to increase said mass flow rate when the temperature of said catalyst is less than a predetermined catalyst temperature value, and to decrease said mass flow rate when the temperature of said catalyst is more than a predetermined catalyst temperature value.

36. An ICE system as in claim 35 wherein ICE ignition timing is retarded when the temperature of said catalyst is less than a predetermined catalyst temperature value.

37. An ICE system as in claim 33 further comprising a bypass duct and a bypass valve; said bypass duct arranged to bypass said ejector pump; said bypass valve arranged to control air flow through said bypass duct; said bypass valve arranged to close when a control condition is met; said control is selected from the group consisting of 1) value of said mass flow rate through said driving nozzle exceeds a predetermined mass flow rate value and 2) value of air pressure in said discharge port exceeds the value of air pressure in said suction port by a predetermined pressure value.

38. An ICE system as in claim 33 wherein said ejector pump further comprises a diffuser having a variable area; said diffuser is arranged to decrease in area when the mass flow of said high-pressure air through said supersonic driving nozzle is more than a predetermined high-pressure air mass flow value; and said diffuser is arranged to increase in area when the mass flow of said high-pressure air through said supersonic driving nozzle is less than a predetermined high-pressure air mass flow value.

39. An ICE system as in claim 33 further comprising an intercooler between said discharge port and said intake port for cooling said pressurized intake air.

40. An ICE system as in claim 33 further comprising a turbulence reducing device between said discharge port and said intake port for reducing turbulence of said pressurized intake air.

41. A method for supercharging an ICE comprising the steps of:
providing an ICE having a combustion chamber;
providing an intake passage for flowing intake air into said combustion chamber;
providing an ejector pump having a suction port, supersonic driving nozzle, and a discharge port;
providing an intake air supply;
compressing atmospheric air in a compressor to generate high-pressure air;
feeding said high-pressure air generated by said compressor into said driving nozzle;
producing a supersonic flow in said driving nozzle;
producing a pumping action in said ejector pump;
admitting intake air from said intake air supply into said suction port;
pumping said intake air with said ejector pump; and
feeding air discharged from said discharge port into said intake passage to supercharge said combustion chamber.

42. The method of claim 41, wherein said intake air supply is chosen from the group consisting of atmospheric air, an engine-driven supercharger and a turbocharger.

43. The method of claim 41, wherein said step of feeding said high-pressure air into said driving nozzle further comprises regulating the flow of said high-pressure air in accordance with ICE operating conditions.

44. The method of claim 41, wherein said step of feeding said high-pressure air into said driving nozzle further comprises heating said high-pressure air to above ambient temperature.

45. The method of claim 41, wherein said step of feeding intake air into said intake passage further comprises pressurizing of said intake air in a second stage supercharger.

46. The method of claim 43, wherein said step of compressing atmospheric air in a compressor further comprises operating said compressor by a power source selected from the group consisting of ICE output shaft, electric motor, and power train of an automotive vehicle.

47. A method for operating a supercharged ICE comprising the steps of:
providing an ICE having a combustion chamber and an intake passage for flowing intake air thereto;
providing an ejector pump having a suction port, driving nozzle, and a discharge port;
operating said ICE;
providing an intake air supply;
providing a high-pressure air supply;
determining ICE output power demand;
determining flow rate of high-pressure air for feeding into said driving nozzle;
feeding high-pressure air from said high-pressure air source at a predetermined flow rate into said driving nozzle to produce pumping action within said ejector pump;
admitting intake air from said intake air supply into said suction port;
pumping said intake air with said ejector pump;
feeding air discharged from said discharge port into said intake passage to supercharge said combustion chamber.

48. The method of claim 47, wherein said step of determining ICE power demand further comprises sensing at least one ICE operating parameters chosen from the group consisting an ICE output shaft torque, ICE output power, engine rotational speed, intake port pressure, combustion chamber pressure, fuel flow rate, position of accelerator pedal, and speed of the vehicle in which the ICE is installed.

49. A method for operating an ICE during cold start period comprising the steps of:
providing an ICE having a combustion chamber, an intake passage for flowing intake air to said combustion chamber, a spark ignition system, a catalytic converter for receiving exhaust gases from said combustion chamber;
providing an ejector pump having a suction port, driving nozzle, and a discharge port;
operating said ICE;
providing an intake air supply;
providing a high-pressure air supply;
sensing the temperature of said catalytic converter;
determining appropriate flow rate of high-pressure air for feeding into said driving nozzle;
feeding high-pressure air from said high-pressure air source at a predetermined flow rate into said driving nozzle to produce pumping action within said ejector pump;
admitting intake air from said intake air supply into said suction port;
pumping said intake air with said ejector pump;
feeding air discharged from said discharge port into said intake passage to supercharge said combustion chamber.

50. The method of claim 49, wherein said step of feeding air discharged from said discharge port into said intake passage to supercharge said combustion chamber further comprises retarding ICE ignition timing.

51. An automotive vehicle comprising an ICE, a means for establishing demand for power from said ICE, a compressor, an air tank, a means for operating said compressor, an ejector pump comprising and inlet, and outlet, and a supersonic driving nozzle;
said ICE having a combustion chamber;
said compressor fluidly connected to said air tank and adapted for providing compressed air thereto;
said air tank fluidly connected to said supersonic nozzle and adapted for flowing compressed air thereinto;
said inlet fluidly connected to a source of intake air;
said outlet fluidly connected to said combustion chamber.
